(19) United States
(12) Patent Application Publication
(10) Pub. No.: US 2004/0012630 A1
(43) Pub. Date: Jan. 22, 2004

(54) Process for automatically creating and controlling a set of graphical objects in a client-server environment

(76) Inventors: Dirk Carels, Melle (BE); Steven Verhoest, Gentbrugge (BE)

Correspondence Address: George O Saile, 28 Davis Avenue, Poughkeepsie, NY, 12603, US

(21) Appl. No.: 10/275,391

(22) PCT Filed: May 3, 2001
(86) PCT No.: PCT/EP01/05179

(51) Int. Cl. G09G 5/00; G06F 7/00

(52) U.S. Cl. 345/760; 707/101; 707/102; 345/968

(57) ABSTRACT

Process for creating and controlling on a client computer a set of graphical objects. A library of graphical objects or components is arranged, each component having attributes, operations and cloning capability for the purpose of assembling a set of instances of said objects on the screen. The cloning process of the different object is controlled by means of cloning instructions contained in a set of property files loaded on the server or generated at run-time by the server for the purpose of producing a wide variety of different instances and graphical screens. Each instance is associated with one property file and the selection by the user of one instance on the client causes the triggering of the associated property file and the control of a new cloning process.

### TECHNICAL FIELD OF THE INVENTION

The invention relates to communication systems and more particularly to a process for automatically generating and controlling a set of graphical objects in a client-server environment.

### BACKGROUND ART

The Internet, intranet networks and the World Wide Web (WWW or web) have been subject of immense development. The web has become the basic and predominant way to publish and disseminate information throughout the world and, today, no industry, company or organization of any importance is planning future development without including a web site. The impact of the Internet is such that any computer which is marketed in the world, is now supplied with an information access/management tool such as a browser, for instance Netscape (manufactured by Netscape Inc.), or Internet Explorer (manufactured by Microsoft Corporation of Redmond, Wash., U.S.A.). The browser is used for accessing addresses on the Internet network and constitutes the heart of the interaction between network servers and the user's machine. New additional plug-in codes are continuously enriching and expanding the browsers with new functions and new capabilities.

In parallel, the HyperText Mark-up Language (HTML) format has become a standard for the publishing of information throughout the world. The HTML format, which is derived from the previous Standardized General Markup Language (SGML) format, has shown to be adaptable for the transmission and the publication of basic and relatively static information. Thanks to the Hypertext linking properties of an HTML document and the breakdown of the basic information in different small elements, the HTML pages are easily transmitted through the network even for users having a low-speed modem connection.

If the HTML format is generally recognized to be effective and adaptable for basic and relatively static information, such as that which is involved in the implementation of electronic catalogs or support of electronic business, it, however, has some strong disadvantages which are to be considered in the context of the requirements of complex client-server applications, and above all, sophisticated business applications.

A first and essential drawback is the static structure and arrangement of the individual HTML pages. No change is possible to one individual element of the page. Any modification which is needed to be made to one elementary piece of information which is being displayed to the user, causes he whole HTML page to be discarded by the browser. No matter how important the change is, the whole page must be dropped and the browser has to initiate a HyperText Transfer Protocol (HTTP) request to request a new HTML page and it has to wait until it receives the new page. When a user is surfing, the browser executes a continuous refresh processing of the HTML pages. Obviously this entails the immediate consequence that web site designers have to design, construct, store and maintain a large number of different pages in the server. Above all, traffic will be substantially increased since complete HTML pages need to be transmitted again and again. This results in a non-negligible waste of time for users, particularly for those having a low-speed modem connection. The organization of the HTML pages in frames can slightly improve the situation, but not without the cost of additional drawbacks. Even if a user is prepared to accept an additional delay when he or she is jumping from one site to another, encountering the same delay in the same web site quickly feels excessive.

It should be noted that not only the delay for accessing the desired information is being affected, but also the overall relationship and interaction between the user and the web site. Comfort and ease in accessing a server are adversely affected by the normal operation of HTML. For instance, if the user is not aware of the particular location of a HTML page where he or she may find the information the user is looking for, he or she might have to consult dozens of pages within the same web site in order to identify the precise location of the page needed. Consider for example the client-server environment which is represented h FIG. 1. Two clients, respectively client 1 and client 2, have access to a server 3 via a Global Communication Network 4, such as for instance the Internet or an Intranet network. In this situation, each client has a browser for handling the Transport Control Program—Internet Protocol (TCP/IP) necessary for requesting HTML pages from the server 3. Assume that the web site has the structure which is depicted in FIG. 2, a home page 21 containing three elementary hypertext links A, B and C which respectively lead the browser to request and to load a first HTML page 22, a second HTML page 23 and a third HTML page 24. First HTML page 22 itself comprises three hypertext links A1, A2 and A3 which respectively lead the browser to request and to load a page 25 (comprising links A11, A12 and A13), a page 26 (with links A21, A22 and A23) and a page 27 (with links A31, A32 and A33). Similarly, second HTML page 23 displays three hypertext links B1, B2 and B3 which respectively lead to a page 28 (comprising links B11, B12 and B13), a page 29 (with links B21, B22 and B23) and a page 30 (with links B31, B32 and B33). Finally, the third HTML page 24 includes links C1, C2 and C3 which respectively causes the request and the loading by the browser of a page 31 (with links C11, C12, C13), a page 32 (with links C21, C22, C23) and finally a page 33 (comprising links C31, C32, C33).

The tree or hierarchical structure which is illustrated in FIG. 2 shows that if the user wishes to access page 25, he or she will need to successively load home page 21 and then page 22. If the user now wants to reach page 31, he or she will need to go back to parent page 22, then again to grandparent page 21 in order to have the possibility to go down to page 24 and, finally, access the desired page 31. The number of steps for reaching the information increases, resulting in additional delay and, above all, less comfort in the use of the system. From this very simple example, it is clear that, in addition to the successive delays which are involved by the refresh procedure (particularly if large images are incorporated in the intermediate pages), the general convenience and comfort of the interaction between the user and the server is adversely affected.

If that inconvenience can be overlooked when the sole aim of the web site is to present relatively static information, it is clear that the inconvenience will be prohibitive if a complex interaction is required between the client and the server, which is precisely the case in business applications. The HTML format does not fit the sophisticated applications which involve the handling and management of complex data mining structures in a client-server environment, and particularly when the application is designed for accessing a remote data base. By accessing a data base, a user may wish to see, for instance, the different attachments and data relating to one business unit. Particularly, the user may wish to easily add, edit and list the records which are stored within the database in a user-friendly and comfortable way, without excessive access delays. In the usual HTML design, it would be necessary to design a great number of HTML pages for supporting those functions. Additionally, it immediately appears that if the user wishes to edit a data in one field or a form, it would be necessary to load a complete new HTML page—which contains the same basic information—but with a different format for the purpose of highlighting the considered field which may be edited, for instance, and provide the user with a visual feedback confirming that the edit operation is rendered possible. The HTML usual way shows low flexibility when it is required to navigate through complex data mining, and has the consequence of multiplying the number of HTML pages to be elaborated for business applications, and this is much more relevant for data base business applications. The tasks of web designers is substantially increased since they have to create, to elaborate and to maintain an application which involves a great number of HTML pages. If the HTML format is not suited for the remote access and for the handling of complex data structure, the situation can be slightly improved by the use of some languages, such as eXtensible Stylesheet language (XSL) used in conjunction with extensible Markup Language (XML).

Obviously, some of these drawbacks could be avoided by reconsidering the opportunity of the HTML format and by preferably using a specific application which would run into the user's computer and which would allow a remote access to the database in a way which is more adapted to the business application requirements. However, this alternative—which is that generally favored in the traditional finance and banking applications—requires an installation procedure of a specific and dedicated software program in the client machine, what involves the need of an installation CDROM or diskette, as well as a complete setup process for installing the files on the hard disk drive, the loading of Dynamic Library Links (DLL) files, the updating of the registry, the rebooting of the machine, and last but not least, the handling of possible conflicts within the machine . . . . Basically, all the benefits resulting from the existence of the ready-to-use web browser would be lost, and thus the possibility to access a remote database from any basic and generic personal computer.

Therefore, there is a need for a new arrangement which takes advantage of the pre-existing browser within a user's computer, and which allows the creation of highly sophisticated applications, such as business applications with complex data mining structures.

### SUMMARY OF THE INVENTION

It is an object of the present invention to provide a new arrangement which permits to use in a more efficient way the preexisting browser and which allows an easier design of complex business applications.

It is another object of the present invention to provide a process for generating and controlling a set of graphical components which are to be assembled and displayed through a browser, at run time, and with a minimum amount of traffic being exchanged between the client and the server.

It is still another object of the present invention to provide a process by which it is rendered possible to design a database business application which allows an effective client-server connection via a Global Communication Network, such as, for instance, an Internet or Intranet network.

It is another object of the present invention to provide a new way for navigating into a data structure and, more particularly, a process by which it is made possible to generate and control a menu graphical object being displayed by a browser and which gives a direct access to a complete data structure existing into a database.

It is still a further object to provide a thin-client front end which can be fully based on a XML architecture.

It is an object of the present invention to provide a new and effective navigation tool.

These and other objects of the invention are achieved by means of the process which is defined in the set of claims. Basically, there is provided a process for automatically generating and controlling, in a client-server environment, a set of graphical objects which are to be assembled in a plug-in container associated to a web browser and displayed in a client's machine. A library of graphical objects or components—i.e. classes receiving attributes and operations (or behavior)—is being arranged, and each graphical object has the corresponding piece of code for executing said operations, including cloning capability for the purpose of producing instances of the class which are to be assembled within said plug-in container and displayed on the screen in the client's machine, with particular attributes and behavior or operations controlled by a set of Cloning Control Instructions (CCI) being provided by the server. The set of Cloning Control Instructions (CCI) is used for controlling the instantiation of the different objects involved in the corresponding tasks.

The process for automatically generating and assembling the graphical objects into the plug-in container includes the steps of:

cloning under the control of Cloning Control Instructions (CCI) provided by the server, which are either extracted from a set of property files or also generated at run-time, a set of objects comprised within said library and which are involved by a considered task;

assigning to each clone the attributes and the operations required by said task in accordance with said Cloning Control Instructions (CCI), said operations including, in response to the selection of said clone by the user, the triggering of a new set of CCI instructions for the purpose of initiating a new cloning process;

assembling the different clones in one document and opening it into said plug-in container associated with a web browser in the client's machine.

When a user selects one particular clone or instance, a new cloning process under control of a new set of CCI instructions is invoked. For that purpose a new property file is triggered or, alternatively, a new run-time process is triggered on the server. Consequently, the new cloning process causes the assembling, within the plug-in container associated with the existing web-browser, of a new set of objects or instances which comply with the new task which is being considered. All of the objects being assembled include the attributes, behavior and operations (including data). All of the objects are derived from the classes which exist in the library being embedded within the document opened by the plug-in container. They thus contain all of the logic and mechanisms required for achieving the desired tasks and only the CCI instructions and triggering commands are needed to be exchanged again during the successive elaboration of graphical screens. Therefore only a very small amount of data is required for successively assembling the different graphical screens of the business application, what ensures a short time response to the user. This reduces the traffic between the server and the client for assembling the different objects within the plug-in container and, eventually, reduces the navigation delay. When the user makes a selection of one graphical object, the new cloning process causes the automatic generation of a new screen which is dedicated to the following task. That is achieved thanks to the assembling of new instances, with new attributes and operations corresponding to the new task. The new cloning process is executed under the control of appropriate Cloning Control Instructions which are provided by the server.

Since the particular attributes and operations are assigned to each particular instance or object in real time, the same object which is contained in the library can be used for a wide variety of tasks and different screens which are to be constructed and assembled within the plug-in container. The cloning mechanism has flexibility even for a complex business application, because it no longer requires web designers to design, construct and maintain a large number of HTML pages.

Further, each object or instance can be individually controlled by a corresponding set of CCI instructions and that reduces any delay for displaying successive screens, even if the user has a low speed modem connection.

Preferably, when a business application is used for accessing a remote data base, the cloning process is based on CCI instructions which can either be derived from property files or be generated in real time by a specific process running on the server. The cloning process produces clones which have attributes and operations, including data that may have been extracted from or loaded into the data base. The cloning process causes instances of the graphical objects to be assembled in the container, when appropriate, with the relevant data to be displayed. Individual controls, behaviors, operations and visualizations of the graphical components are achieved in real time and are easily changeable contrary to the usual way that HTML works.

The cloning mechanism can be used with different objects which can be assembled in the plug-in container.

In one embodiment, the library includes one generic button class which has the operations and logic for achieving the assembling of one graphic button into the plug-in container. The generic button object receives attributes and operations under control of the CCI instructions. Those CCI instructions are either derived from a property file on the server or, alternatively are generated in real-time by the latter for the purpose of assembling a relevant instance of a graphical button into the container and displaying it on the screen. The attributes include the name, the size, the color and the position of the button which is to be assembled on the screen and within the plug-in container. In addition, the button object includes an operation which causes the triggering of one corresponding property file located on the server, for the purpose of executing and controlling new cloning operations required for the next task when the user selects the graphical button.

In another embodiment of the invention, the library includes a combobox object for producing clones which receive, during the cloning operation, attributes and operations for displaying a selection box in the user's machine, optionally with data extracted from the database. The combobox object includes the logic and mechanism for invoking, in response to the actuation by the user, a new set of CCI instructions extracted from a property file or computed at run-time by the server, for the purpose of causing a new cloning process corresponding to a new task.

In a further embodiment of the invention, the library includes a listbox object which has the logic and mechanism for being assembled into the plug-in container. Additionally, each instance of the listbox object receives, during the cloning operation, attributes and data extracted from said database, and also operations for particularly invoking, in response to the actuation by the user, a new set of CCI instructions derived from a property file on the server or, alternatively generated by the latter in real-time. Similarly to the other objects, those CCI instructions are used for executing and controlling new cloning operations corresponding to a new task.

In one particular embodiment, the library comprises a graphical menu object which is used for assembling within the plug-in container an automatic drill-down menu. The menu object is used for producing clones or instances which receive attributes and operations, as well the cloning capability, and the capability to delegate the cloning capability. Each clone particularly receives a name during the its cloning process, and the possibility to generate new clones. Therefore, the cloning process causes the assembling within the plug-in container of a set of instances which are hierarchically arranged and displayed to the user. That achieves an aggregate new object which has automatic drill-down menu capability. By positioning the cursor on one instance composing the new aggregate object, the hierarchical structure of the tree can be automatically displayed without requiring additional TCP/IP messages which would be necessary in the usual HTML pages. The drill-down capability results from the properties assigned to the different instances of the graphical menu object, which were instantiated under control of the Cloning Control Instructions (CCI) extracted from the property files or produced at run-time by the server. In addition to the drill-down capability, each instance of the menu graphical object receives the operation of invoking a new set of CCI instructions upon actuation by the user. This causes the execution of a new cloning process and, finally the elaboration of a new graphical screen based on the objects or classes existing in the library. Therefore, a very limited set of objects can be used for producing a wide number of successive screens and the drilling-down menu permits one to get a direct access to any location within the data structure. The successive refresh operations and intermediate HTML pages which were evoked in the prior art solutions can be avoided. A quick, comfortable and very effective access to the database is thus provided, even from a remote location.

More particularly, each document which is opened by the plug-in container causes the creation of a background screen which is also derived from an object contained in the library of graphical objects embedded within said plug-in container. The background screen receives, in the foreground, instances of the graphical objects which are extracted from the library. The instances of the graphical objects are created during the generation of the screen, and receive data in accordance with cloning instructions which are defined by Cloning Control Instructions (CCI) which are extracted or derived from property files located on the server, or computed by the latter at run-time. Therefore, the background objects and the foreground objects can be individually modified and allow effective access to the data structure even with a low speed modem connection.

It can be seen that each graphical object of the library may be used for automatically generating and controlling, at run time, a wide variety of different screens, which facilitates the work for web designers who are no longer compelled to create, construct and maintain a large number of HTML pages which would have normally been needed for realizing a business application. Only the set of CCI instructions needs to be defined. The association of the cloning process and a preexisting library of graphical objects can even provide a very effective development tool for achieving quick and sophisticated business applications.

Since the preexisting browser of the client machine is used for handling the TCP/IP connections in cooperation with the plug-in container in accordance with the invention, no installation of any additional program or software package is required. If necessary, the corresponding plug-in can be directly downloaded during the first connection to the server. Any typical computer can thus be used for the purpose of achieving an effective and user-friendly access to a remote database via the Internet network.

It should be noted that, independently of the context of a web browser and any connection to the Internet network, the invention provides a new navigation tool which is based on a locator which allows an easy way to explore the different pages of a data structure which can be displayed by the browser. Basically, the controllable graphic menu involves a drilling menu representing a hierarchical structure of pages or screens, a locator line providing the succession of levels which have lead to the current page which is being displayed, and means for causing the display of the drilling menu when the user points to one particular level of the locator and means for directly accessing the new page in accordance with the new position of the page upon selection by the user. More particularly, the invention provides an access to the database where the messages which are exchanged between the client and the database comprises a coded representation of the tree and the data structure so that the data structure can still be displayed without the need of further transmission of pages. This navigation process provides the advantage of saving space on the screen, since the user is provided with complete access to the data structure while it is no longer necessary to display all of the structure, but only the history line of the currently displayed page.

### BRIEF DESCRIPTION OF THE DRAWINGS

Embodiments of the invention will now be described, by way of example only, with reference to the accompanying drawings, wherein:

FIG. 1 illustrates the basic client-server environment.

FIG. 2 is an example of a structured set of HTML pages in a prior art solution.

FIG. 3 is an illustrative example of the environment which is involved in a database business application.

FIG. 4 and FIG. 5 respectively illustrate a generic combobox and a generic listbox.

FIG. 6 illustrates the process of assembling of a menu object which is used for achieving an aggregate object having automatic drill-down menu capability.

FIG. 7 is a flow chart illustrating, in Unified Modeling Language, the process which is involved during the logon and password checking procedure.

FIGS. 8 is an exemplary screen that is displayed to the user during the logon and password checking procedure in the preferred embodiment of the invention.

FIG. 9 shows the screen displayed to the user when the observer.swf movie waits for the receipt of the CCI instructions involved in the cloning process of different tower objects.

FIG. 10 is a flow chart in the Unified Modeling Language (ULM) format which illustrates the process of assembling, under control of the CCI instructions, a different tower which is assembled into the plug-in container in accordance with the user's profile.

FIG. 11 illustrates the result of the process of FIG. 10 which is displayed to a first user which is an Administrator having extended access rights to the database, and to the business functions involved in the access of that database.

FIG. 12A illustrates the result which is displayed to a second user having reduced access rights to the business functions of the database.

FIG. 12B shows how to arrange the FIGS. 13 and 14 for the purpose of assembling a comprehensive view of the drilling-down menu generation process.

FIGS. 13 and 14 are a flow chart which represents, in the ULM format, the automatic generation of the drilling-down menu as represented in FIG. 6.

FIG. 15 is a flow chart illustrating the process of assembling the different elements composing the navigator.

FIG. 16 is a flow chart illustrating the process for assembling the different elements composing the locator.

FIG. 17 illustrates the assembling of the first instance of the menu item object composing the navigator-locator drilling menu.

FIG. 18 illustrates the creation and assembling of five instances derived from the first instance of FIG. 17, for the purpose of achieving the first drill-down processing of the menu.

FIG. 19 shows the reiteration of the cloning process being executed upon the actuation of the “initials” menu instance.

FIG. 20 illustrates the assembling within the plug-in container of the result of the cloning process which is executed in response to the actuation by the user of the ADD instance of the drilling-down menu shown in FIG. 19.

FIG. 21 illustrates the assembling within the plug-in container of the result of the cloning process which is carried out when the user selects a combobox of FIG. 20.

FIG. 22 illustrates the assembling within the plug-in container of the result of the cloning process executed in response to the user actuating the “save” graphical object of FIG. 21.

FIG. 23 illustrates the assembling within the plug-in container of the result of the cloning process executed in response to the user actuating the “edit” graphical object of FIG. 20.

FIG. 24 illustrates the assembling within the plug-in container of the result of the cloning process which is executed in response to the actuation by the user of the List graphical object shown in FIG. 19.

FIG. 25 is another example of the assembling of different instances composing the aggregate drilling-down menu object.

FIG. 26 illustrates the assembling within the plug-in container of the result of the cloning process executed in response to the user actuating the “Add” graphical object of FIG. 25 and evidencing the role of the locator.

FIGS. 27 and 28 are illustrative views of the top menu assembling process when the user selects the “Project and time report” Tower object which is illustrated in FIG. 11.

FIG. 29 illustrates the Content frame and FIG. 30 shows the screen which is constructed during the waiting process of the CCI instructions generated by the server for the purpose of creating the first main menu item.

FIG. 31 shows a particular embodiment of the invention which is based on the use of the XML format for conveying the CCI instructions.

FIG. 32, illustrates the screen for designing a graphical component in accordance with the invention.

FIG. 33 illustrates a preferred embodiment of the invention.

FIG. 34 illustrates the control of the view of FIG. 31.

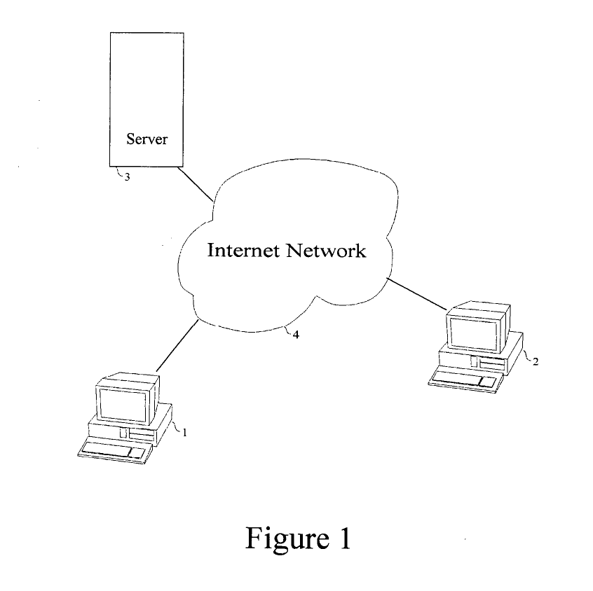

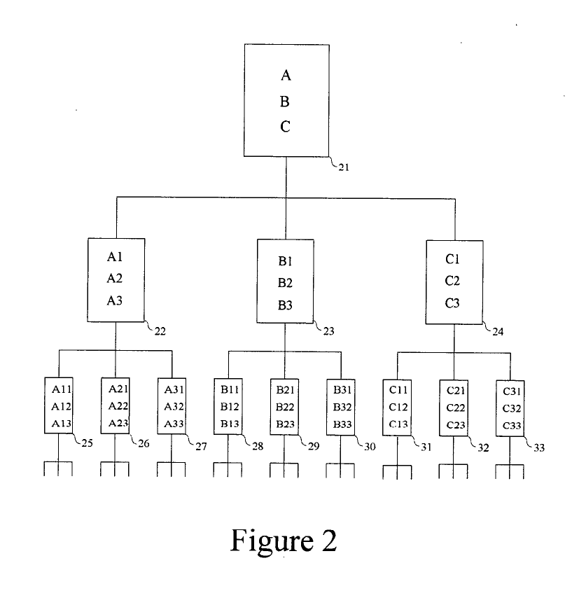

### DETAILED DESCRIPTION OF THE PREFERRED EMBODIMENTS

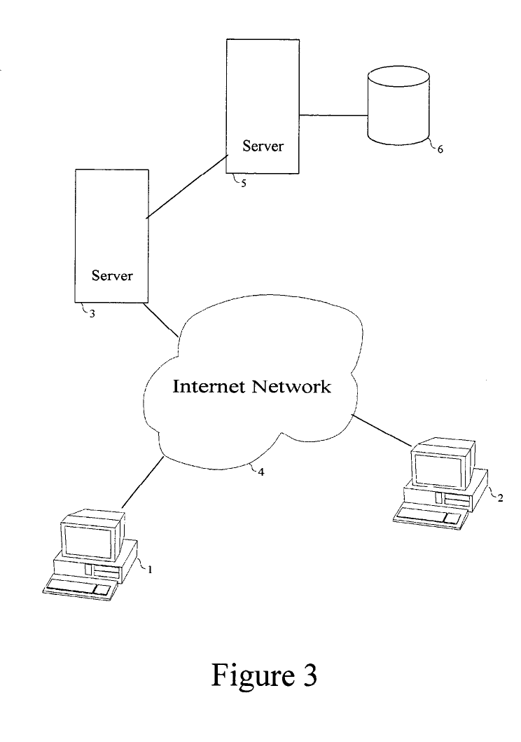

With respect to FIG. 3, there is shown a basic client-server environment which can take advantage of the present invention. Two clients 1 and 2 are attached to a Global Communication Network 4, such as the Internet or an intranet network. A server 3 is also connected to the network and serves as an intermediate layer or middle tier for interfacing with a server 5 having a direct access to the database 6, such as DB2, ORACLE, SQL, etc. The invention will be described with reference to a business application, for instance an Enterprise Resources Planning (ERP) application which can be used, for instance, for the purpose of real-time inventory or purchase procurement management.

In the preferred embodiment, each client 1 or 2 has a browser such as Internet Explorer 4 or Netscape 2, for instance, which is fitted with an additional plug-in package serving as a container for parsing data, i.e. opening documents and generating graphical animations on the screen and having fill-in forms capabilities. The browser is particularly used for handling the TCP/IP connections with the server. Specifically, as known by one of skill in the art, the browser transmits POST or GET requests to the server and receives the corresponding information via the TCP/IP message system, and opens it through the plug-in.

The process is based on the use of a library of graphical components or classes of objects for creating clones of the objects which receive attributes and operations (or behavior) for the purpose of being assembled, in real time, within the plug-in container in accordance with the requirements of each particular business task. Each component of that library is a generic object which receives all the logic and mechanisms corresponding to a determined task. The behavior further includes the cloning ability for the purpose of creating new instances with specific attributes and operations. The cloning of each generic object of the library is automatically achieved in real time, as will be explained below with many details, thanks to a set of Cloning Control Instructions (CCI). In one embodiment, those CCI instructions are directly derived from a set of property files which are physically loaded on the server. Alternatively, the cloning instructions can be produced, in real time, from a process which is run on the server and which can access one database. In the remaining part of the description it will be assumed that a set of property files will be used for producing the CCI instructions being used for controlling the cloning process of the different classes or objects of the library which are, eventually, assembled into the plug-in container. By creating and maintaining the sets of property files, web designers are given an effective development tool for generating a business application, however complex and sophisticated it is. Generally speaking, the cloning instructions which are contained in the property files define the information which determines, for each class or object identified in the library, the number of instances to be instantiated and assembled within the plug-in container and the appropriate attributes and operations which are to be assigned for each clone, including, when appropriate, the data extracted from the database 6. The assembling within the plug-in container of the objects which are involved by a given task can be easily achieved. The behavior of each particular instance of a graphic object that is assembled, comprises the capability of triggering a new property file (or alternatively a new real-time computation of the CCI instructions) when the user actuates the corresponding object or instance which is displayed on the screen. A new cloning process is initiated which is controlled by a new set of CCI instructions and, therefore, results in the assembling of new instances of objects from the library so that a new task and a new screen can be assembled and displayed. As mentioned previously, the CCI instructions define the number of instances to be created and displayed, with the attributes and properties—including data—to be assigned to each instance for a final assembling within the document opened by the plug-in. The different instances cause the assembling of an appropriate graphical screen corresponding to the business task being desired, since each instance of the graphical objects is assigned the specific attributes and specific operations which corresponds to that task. A wide variety of different screens and tasks can thus be achieved even if the library only contains a limited number of objects. It is possible to design screens and tasks for the purpose of adding a new supplier record, editing an existing supplier record etc. When the set of instances of the graphic components of the library has been created, with the assigned attributes, operations and data, the result of the cloning process is transmitted via the TCP/IP protocol managed by the browser to the plug-in for the purpose of assembling the result in the client's machine.

The description below will provide examples of the great variety of objects which can be assembled in accordance with the new cloning mechanism. Such objects which include, without limitation, a generic button, a generic combobox, a generic listbox, a generic entrybox and, additionally, a generic drilling menu or navigation tool, are included in the library.

A first object or graphical component consists of a generic button object comprising the logic and mechanism for producing clones or instances which are to be assembled within the plug-in container, with attributes and behavior, including, when appropriate, data extracted from the database 6. The attributes of the button graphical object may particularly include the name of the instance, the text to be displayed on the screen, the size, the location and the color on the screen etc. During the run-time cloning process, each instance of the generic button object receives operations which includes, among other things, the loading of a new document and the triggering of one associated property file existing in the server, as will be explained below.

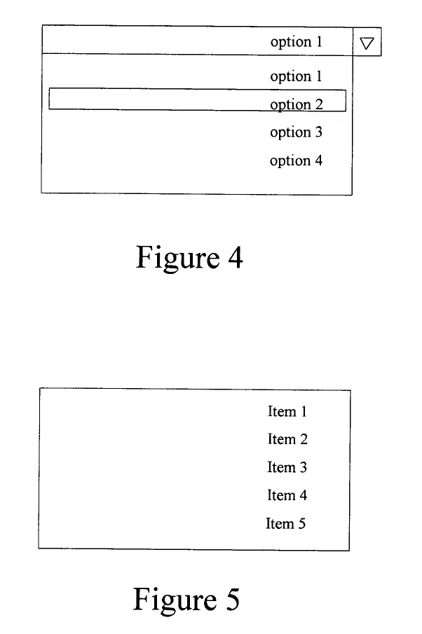

In addition to the generic button graphic object, the library may include a combobox generic component which is an element causing the opening of a list of options for the purpose of selecting one particular option within the list. Such a combobox is shown in FIG. 4. The generic combobox includes the logic and mechanism needed for producing clones or instances having their own logic for achieving assembly within the plug-in container. Each instance of the combobox further receives, under control of CCI instructions, the attributes, operations and data extracted from the database for the purpose of assembling the graphical screen. Similarly as that for the button class, the attributes of the combobox instances include the name, the size, the data displayed in the options fields etc. Among the operations, are included the necessary logic for the appropriate graphical display on the screen, and for applying the option being selected, the calling of a new document in the plug-in recognized, and the triggering of one associated property file which is loaded on the server, for the purpose of executing new cloning operations as will be explained hereinafter.

FIG. 5 shows a listbox which can also take advantage of the cloning mechanism which is executed under the control of the CCI instructions. The listbox is a graphical component which is generally used for opening a box and listing a set of different items or data which is extracted from the database and presented in a list. As for the combobox, the listbox generic component has all of the logic and mechanism which is necessary for producing one corresponding object on the screen when it is assembled within the plug-in container. It also receives the corresponding attributes, behavior and operations. The attributes define the name, the position, the size, and also the operations required for extracting the appropriate data from the database and for introducing them into the generic container. The particular operations which are assigned to one listbox further include the calling of a new document recognized in the plug-in container format, and also the triggering or invoking of one associated property file.

In addition to the combobox and listbox, the library of graphical objects may advantageously include an entrybox which has attributes (the name of the considered instance, the text to be displayed) and operations (validation and checking procedure of the data being entered). The operations further include the triggering or invoking of a new property file on the server upon selection of the user for the purpose of executing a new set of cloning operations.

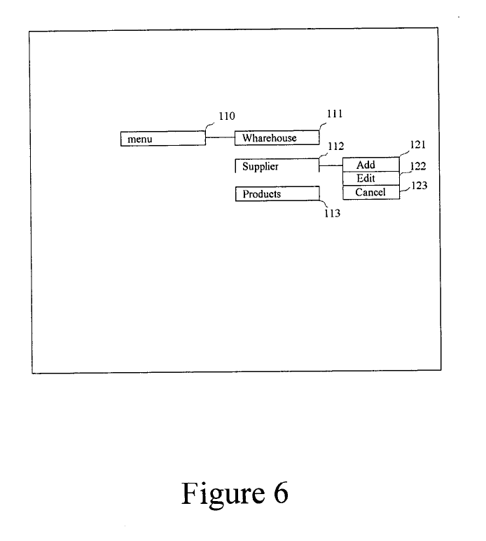

Among the particular graphic objects which are included in the library, there is a specific drilling-down menu component—a so-called Menu_item object—which is used for assembling and providing an aggregate drilling menu, such as shown in FIG. 6. The drilling-down menu—whose creation will be particularly described below with many details—can directly take advantage of the cloning process described above. It achieves the assembling, within the plug-in container, of an aggregate menu which is used for providing the user with a direct access to the entire data structure of the web site without requesting, once created and assembled, additional TCP/IP connections and the transmission of a large number of HTML pages, which the usual HTML design would entail.

The specific elementary Menu_item object which is used within the library is a container having all of the logic and mechanism for creating a hierarchical and drill-down menu in accordance with the contents of the property files. The attributes and operations include cloning capability for producing different clones or instances, similar to the abovementioned combobox or listbox, and also the capability to delegate to the clones or children the cloning capability. The successive execution of the cloning process successively produces a set of instances of the same Menu_item object which, when assembled in the plug-in container, carries out the drilling-down menu. As for the combobox or listbox, the cloning process of the different instances is controlled in accordance with the contents of the property files and allows the generation of an automatic drill-down menu without requiring any additional TCP/IP connections once the different instances of the object have been assembled.

More particularly, the Menu_item object receives attributes and operations for cloning into different instances, and each clone receives, similarly, its own attribute (name) and the same cloning capability. When the user clicks on one clone of the Menu_item object, the active object which was launched by the browser executes the corresponding property file on the server. This is achieved, again, by means of the transmission through the network of an instruction which is received by the application in the server. That instruction is decoded and causes the execution of the cloning process which is defined by the relevant property file. The property file causes the Menu_item object to produce n clones in accordance with the number of business tasks considered. Each clone receives its attributes and operations in accordance with the contents of the property files and, further, produces additional clones. FIG. 6 illustrates the result of the cloning process of the Menu_item object: a unique instance 110 is first produced which receives the name “top menu”, and that instance 110 produces three clones, respectively instance 111, 112 and 113 which receives the name “Warehouse” (for giving access to the business tasks relating to Warehouse records), “Supplier” (for giving access to the business tasks relating to Supplier records) and “Products” (for the business tasks relating to Products records). The property file causes the “Supplier” instance 112 to produce two additional clones: an instance 121 (LIST) of the menu object and an instance 122 (ADD) of the menu object. As explained above, all of the instances of the Menu_item object receive, in addition to the attributes, the operation for executing the corresponding business task, and particularly the triggering of the relevant property file for initiating a new cloning process corresponding to a new task. Among the tasks which are assigned to each instance, there is given the direct triggering of the property file which is associated with the instance being pointed by the cursor, so that a new cloning process is executed and the display continuously refreshes for the purpose of developing the hierarchical tree. The user can thus have a direct access to any level of the data structure.

The result of the cloning process is then received by the browser and assembled in the plug-in container and is thus displayed to the user. That object appears with an automatic drill-down capability. Indeed, among the operations assigned to the instances of the Menu_item component or object, is the capability, as one example, to display the children when the user is pointing to one instance. The process of assembling the different instances of the drilling-down menu component, automatically produces the generation of the drilling-down menu and this is immediately received by the client since only a few kilobyte message is transmitted. This results in a substantial reduction of time and, correspondingly, a substantial enhancement of the comfort of the user who can really navigate through the data structure, even with a slow modem connection to the network. Contrary to the usual HTML design, there is no necessity to receive intermediate HTML pages for navigating within the database. A complete access to the data structure is directly provided by means of the automatic cloning process of the different instances of the drilling-down menu object.

Although the specific drilling-down menu object appears to significantly enhance the cloning mechanism in the perspective of accessing a database in a client-server environment, it should be noted that the drilling-down menu graphical object can be used irrespective of the particular client-server environment, and may serve as an effective navigation tool even for local software applications handling a complex access to a data structure. Indeed, the drilling-down menu which is described above, and the enhanced navigation-locator which will be particularly described below, allows one to drastically save space on the screen since the user is constantly given an immediate access to the complete data structure, without the necessity of displaying all of the different levels of the structure. Further, the access is immediate since only one selection is appropriate for jumping to the desired page.

In the client-server environment, it is clear that the automatic drilling menu substantially enhances the comfort of use of the application since the menu receives the possibility to drill-down without any additional solicitations of the TCP/IP message system. The same TCP/IP message is used for transporting the complete result of the cloning process, what allows the knowledge of the complete hierarchy of the data structure.

The architecture of graphical objects which has been described above, is to be programmed and compiled by means of an appropriate development tool or plug-in. As explained above, in the best mode of operation, the development tool is embodied in the form of a plug-in code or container which is associated with the preexisting browser. The particular interaction between the plug-in and the web browser is well known to one of skill in the art and will not be further explained in detail. It is however sufficient to recall that the plug-in program has its own format and recognizes that format in the documents received from the server and can then open any document having that format and which embodies the application based on the graphical objects architecture. Practically, any development tool can be used for embodying the graphical object architecture, particularly but not exclusively those achieving vector based web sites and receiving variables from external files. An illustrative example of a plug-in or container which can be used for programming the objects is available under the name Flash™ and can be obtained from Macromedia™ Inc.

The objects which are described above are only examples of graphical components which may be controlled by cloning instructions and which are loaded into the property files. According to the particular requirements of the application which is considered, it is possible to create additional and specific objects which can take advantage of the automatic cloning mechanism which will now be described in more detail.

For the sake of demonstrating the effectiveness of the cloning mechanism applied to objects transmitted by a server and opened in a plug-in container associated with the browser of a client machine, it will now be described in detail, with reference to a preferred embodiment which allows access to a sophisticated database by a simple computer having only a pre-existing web browser. Additional advantages of the enhanced navigation tool, the so-called locator-navigator, will also be evidenced.

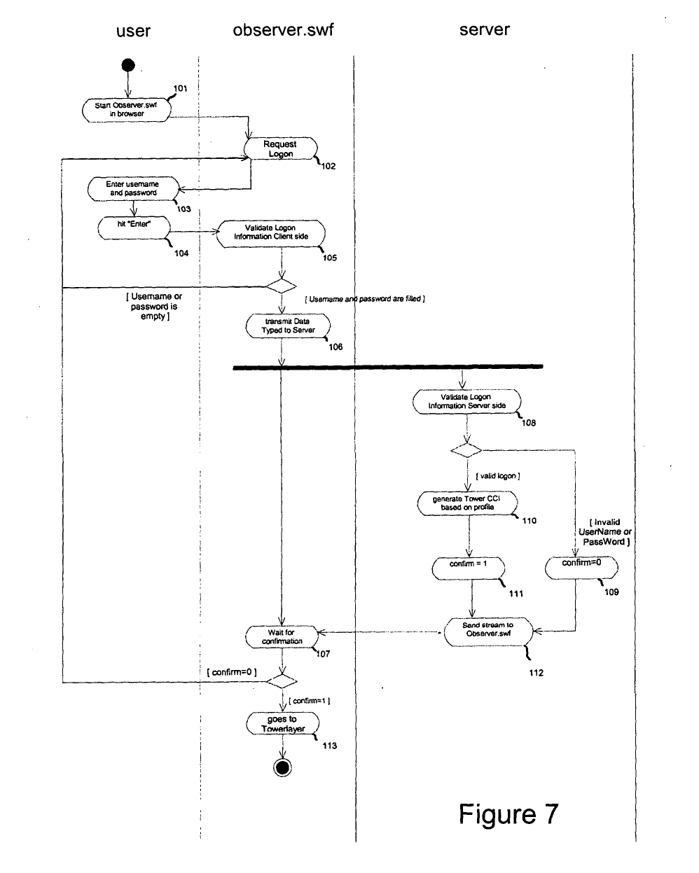

FIG. 7 illustrates the process for assembling the different screens which are relevant in the first part or movie of a business application. FIG. 7 is particularly elaborated with reference to the principles of modeling of the Unified Modeling Language standard, as they are taught, for instance, in the reference book “Unified Modeling Language User Guide” by Grady Booch“.

The process is initiated with the loading of the existing web browser and the request by the user of a Uniform Resources Locator (URL). Although the cloning mechanism is well adapted for accessing remote resources in a server-client environment, it should be noted that the latter can even be used in a local configuration, when the browser issues a URL for requesting a local HTML page existing on the local file system. That first HTML page which will be opened by the browser will remain the first and unique HTML page which is received from the server. That first HTML page comprises the appropriate HTML tags associated with the corresponding information which is required for launching the business application and more precisely the document which will be recognized by the plug-in contained and opened by the latter.

The business application is then bunched, which results in the launching of a first document in step 101—a so-called Observer.swf document—which embeds the library of the graphical objects forming the basis for assembling all of the graphical screens involved in the application, such as the required buttons, combox, listbox etc., and the specific enhanced navigation tool, the navigator-locator. In addition, the Observer.swf document causes the assembling of a first set of objects—at least an entrybox—for the purpose of starting a logon and password checking procedure. In the description, it will be assumed that different kinds of users may access the business application, for example, an Administrator which has extended access rights, and the common user with only limited access rights.

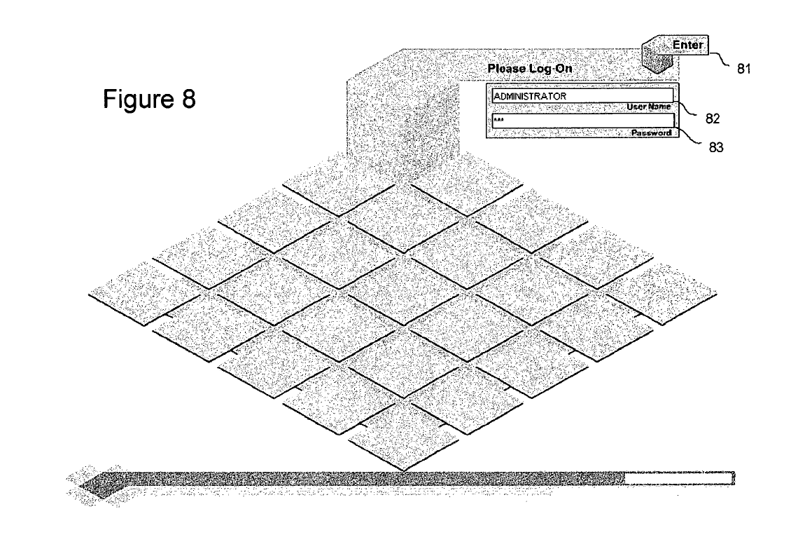

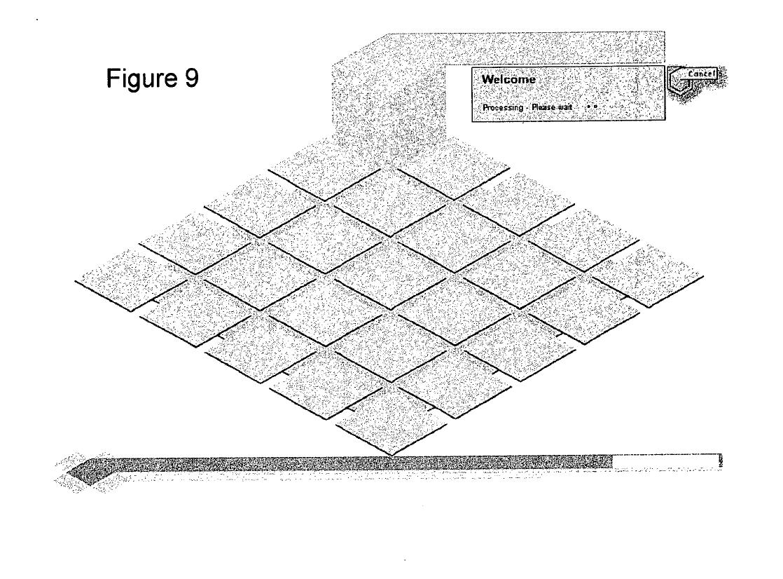

The logon and password checking procedure starts with step 102 which is a “request logon” step corresponding to the assembling of one appropriate screen which is such as that illustrated in FIG. 8. A first instance 81 corresponding to a graphical button object is assembled, as well as two entry boxes 82 and 83 for receiving the userid and the password data of the user. Although this is not absolutely necessary in that stage, the Enter button 83 which is assembled in the screen of FIG. 8 can take advantage of the cloning mechanism under the control of the CCI instructions provided by the server, for the purpose of managing different profiles and languages. When the user actuates the “Enter” key (step 104) after having entered his userid and password as illustrated in FIG. 8 (step 103), the observer.swf starts a validation procedure in step 105 for checking whether acceptable characters are actually entered by the user. In the case of a failure of the validation of the characters, the process goes back to step 102. On the contrary, the userid and the password are transmitted to the server in step 106, which is achieved by means of appropriate POST requests handled by the communication layer of the pre-existing browser. The processing is accompanied by the assembling of a second screen, as shown in FIG. 9, for providing visual feedback to the user of the transmission of the userid and password.

Two processes are executed simultaneously in the observer.swf state machine and in the server.

On one hand, the observer.swf state machine waits for a confirmation (step 107) received from the server of the transmission of the password and the userid. A screen such as that illustrated in FIG. 9 is displayed to the user on the client machine.

On the other hand, the server initiates a validation procedure during step 108 for checking the data entered and determining whether the userid corresponds to an effective one and for validating the password which was entered by the user or the administrator. Appropriate access to a database associated with the server can be involved for that purpose. Such logon and password validation procedures are well known to those of skill in the art and will not be described further. If the userid and the password are not recognized by the server as being a valid one, the test fails, and the process proceeds to step 109 where a CONFIRM variable is reset prior to proceeding with step 112.

In the case of validation of the userid and the password, the process which is executed by the server goes to step 110 where a string of Cloning Control Instructions is elaborated. In the best mode, a number of so-called towers objects (representing different business tasks involved in the business application) are used for materializing different types of access to the data structure, either by the Administrator or by the user. The towers are specific objects contained within the library of objects which receive attributes and properties. Among those is the property of launching a particular business task upon selection of the object, for instance, by the user. If one user clicks on a tower which is displayed, the process will proceed with the construction of a new frame, a so-called Content frame or layer, for the purpose of gaining access to different data mining of the relevant business application, as explained below in more detail. As for any object within the library, every tower instance which is assembled by the observer.swf document is controlled by a CCI which defines the different attributes (e.g., instance name of each clone or instance, but also the name to be displayed on the screen) as well as the properties assigned to the object, once instantiated, and among which, is the property of triggering or invoking a new property file in response to the selection of the instance by the user. The content layer will be described in more detail hereinafter. Although the logic and mechanism involved in the tower object class is embedded in the observer.swf document, the number of instances of that object to create, the attributes and the properties, is defined by the CCI string produced by the process of step 110 run in the server.

In one embodiment, the CCI string can be extracted from an appropriate property file which exists in the file system of the server while, in another embodiment, the CCI stream is directly produced by the server, at run time, thanks to an existing process in accordance with variables and parameters which are loaded into the database.

Further to step 110, the CCI string is completed by a confirmation variable (CONFIRM) which is set to 1 in order to acknowledge the correct building of the CCI string, and the process is run in the server and proceeds then to step 112 which corresponds to the transmission of the CCI string.

The observer.swf process which is executed within the client machine, and run within the plug-in container, receives the CCI string. In accordance with the value carried by the CONFIRM variable, the confirmation step 107 returns a True or False condition. If the CONFIRM variable is set to zero (which occurs either when the logon procedure fails in step 108 or when an error occurs during the elaboration of the CCI string in step 110), the process executed by the observer.swf movie goes back to step 102 while, in the reverse case, the process goes to the next movie, a so-called Towerlayer, in step 113.

In step 113 the logon procedure is completed and the process of the observer.swf document can launch the Towerlayer which results in the assembling of the different tower instances.

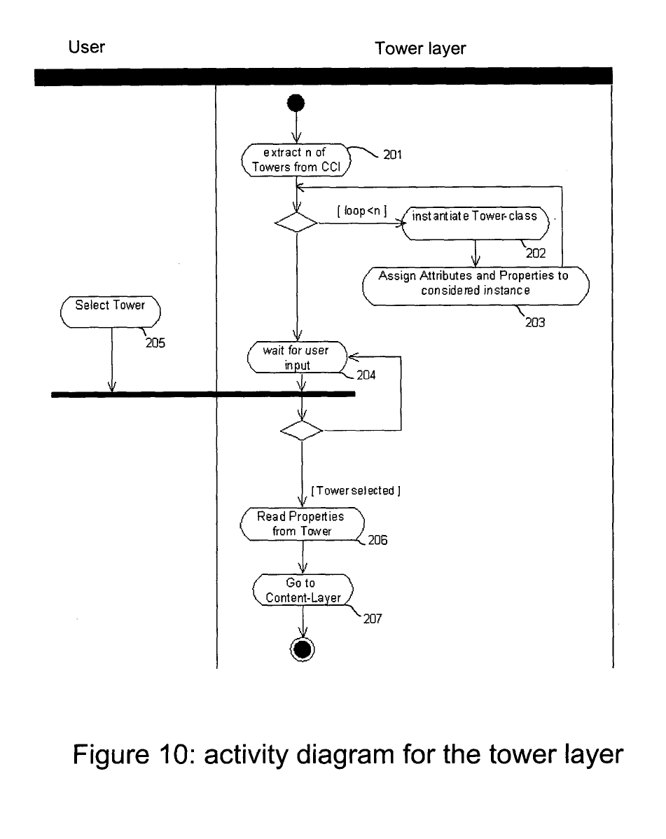

FIG. 10 shows the activity diagram of the towerlayer of the observer.swf process. It is performed in the client machine upon the reception of the CCI control instructions from the server during the logon validation procedure depicted in FIG. 7.

In step 201, the Observer.swf process uses the contents of the CCI instructions for determining the number n of towers instances which are to be elaborated. A loop is then initiated for successively creating the different instances. To achieve this, the Tower class which is embedded in the Observer.swf document is cloned and the clone is instantiated in step 202. Then the appropriate attributes and properties which are defined by the CCI string are assigned to the considered clone in step 203. Then the process loops back for the purpose of a new instantiation, when appropriate.

When all of the items or graphic towers have been cloned and elaborated, the process proceeds to a waiting step 204 where a new input from the user is awaited.

If the user selects one tower instance, which is represented in the Figure by step 205, the properties which correspond to the clone are read in step 206 and then the content layer is launched in step 207. As mentioned above, the launching of the content layer is an operation which is part of the Tower class since the considered clone has received all of the attributes and properties of the tower class. The process then completes.

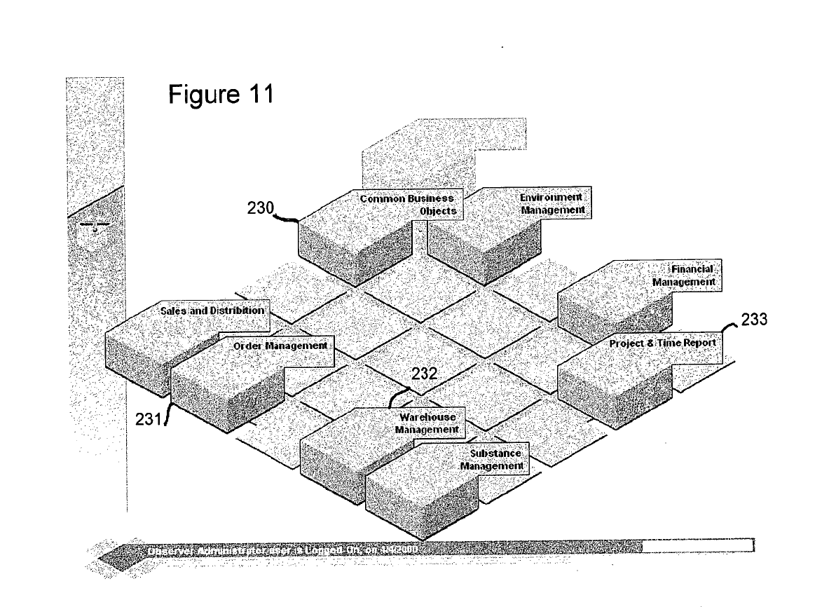

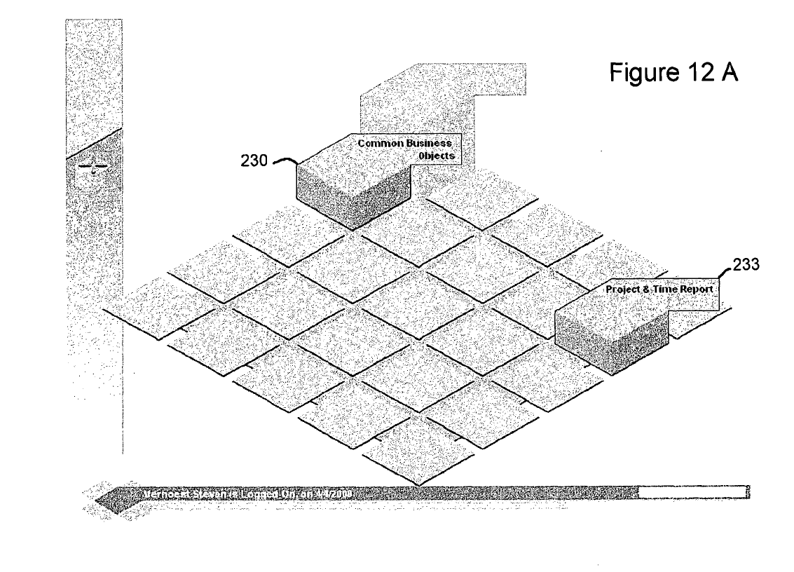

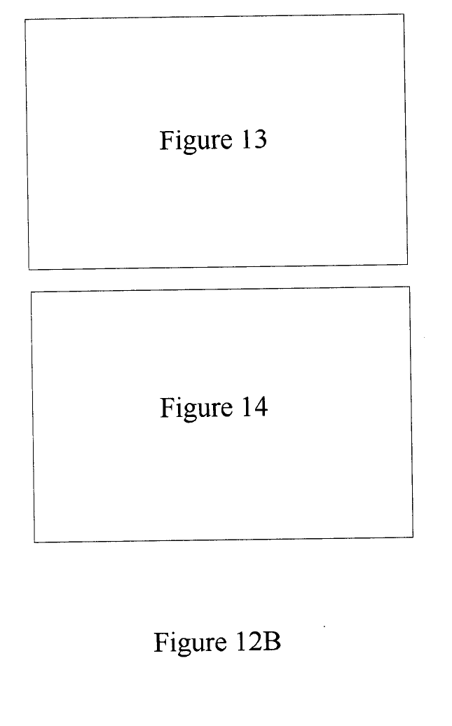

FIGS. 11 and 12A respectively illustrate the results of the cloning process when applied on the Tower class or object, when either the Administrator or the user accesses the business application. Each Tower object which is cloned corresponds to one particular task (hereinafter referred to as a business task) which is relevant to a particular access to the database and the number of individual clones is defined by the CCI string in accordance with the access rights assumed to be assigned to the user. As illustrated in FIG. 11, the Administrator receives extended access rights, what is materialized by a cloning process which assembles numerous tower instances, under the control of the CCI instructions. An illustrative example is shown in FIG. 11 which shows a so-called “Common Business Object” tower 230 for accessing very general information relating to one company, with the description of the premises, the references to the staff etc. A second instance, a so-called “Order management” tower 231, corresponds to the handling of the different orders and commands within the company. A third task—“Warehouse Management” (reference 232)—is used for accessing the information relating to the different Warehouses of one company, while a “Project and Time Report” object 233 deals with project management. The cloning process provides great flexibility since the same object—a tower object—can be used for creating different instances relevant to different situations and environments. The observer.swf file appears to have a reduced size, which facilitates the transmission through the Internet or an intranet network. Indeed, a limited amount of data, essentially the observer.swf file, and subsequent files and the CCI strings, need to be exchanged.

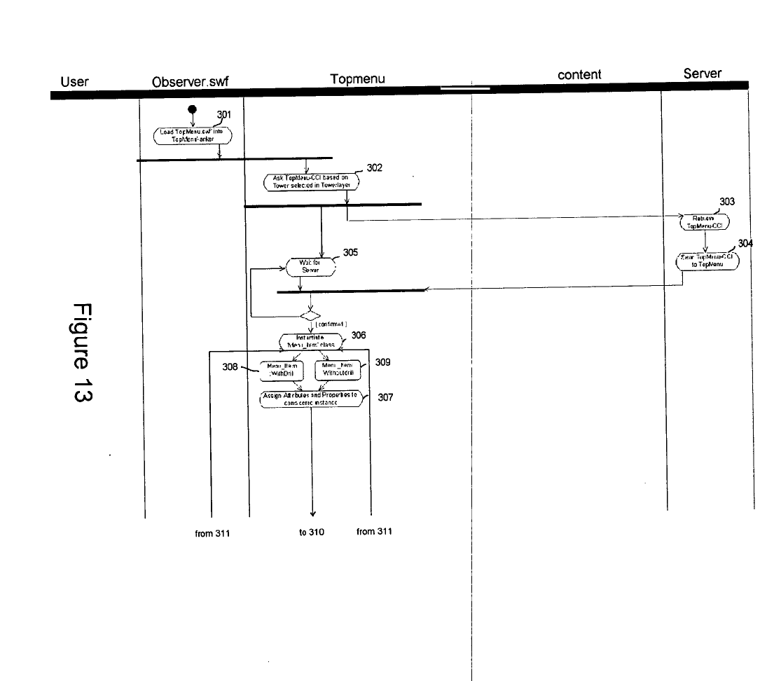

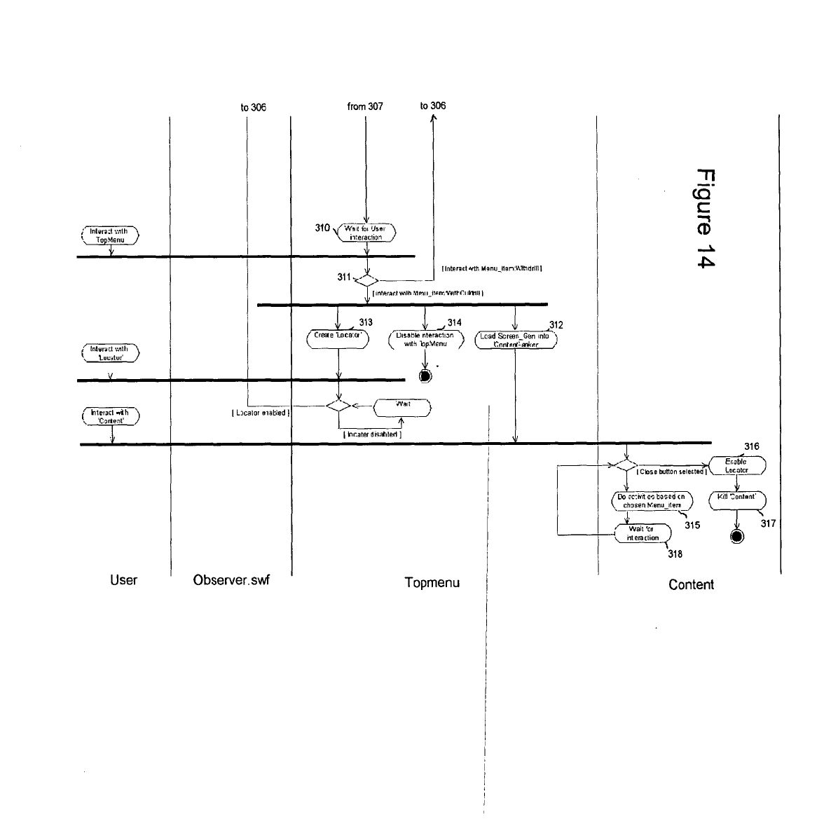

For the sake of clarity, it will be now described how the process can be used for generating sophisticated objects which are useful for the purpose of the business application. The creation of the enhanced navigation tool, the so-called navigator-locator, will now be specifically considered with reference with the flow charts of FIGS. 13 and 14 which should be arranged in accordance with the drawing of FIG. 12B.

The process for assembling the navigation tool starts with step 301 of FIG. 13 which consists of the loading by the observer.swf document of a new document which is named the Topmenu.swf. This is achieved by using an appropriate TopMenu anker, which is a special class into which an external class can be loaded. The techniques of creating and handling ankers is well known and will not be further elaborated on. It should be also noted that the loading of a second Topmenu document is a simple choice of realization. Alternatively, a unique document can be contemplated. Basically, the practical way of calling the new document is dependent on the particular plug-in program or development tool which is being used.

From the instant the Topmenu is loaded, the user interacts with it. In step 302, the process which is executed in the client machine and which corresponds to Topmenu.swf document requests from the server the CCI instructions required for the elaboration of that Topmenu.

In step 303, the server retrieves the Topmenu Cloning Control Instructions. As explained for the Tower CCI, the Topmenu CCI can be extracted from a set of property files (such as text files) or, also, can be generated at run time from data and variables extracted from a database. In any case, it should be noted that the string of CCI only represents a few kilobytes of data transmission between the server and the client, which ensures a very quick transmission and response from the server. That provides a substantial advantage with respect to the known prior art HTML technique.

In step 304, the server sends the Topmenu CCI (finalized with the last item Confirm=1) to the Topmenu.swf document which waits for it in step 305.

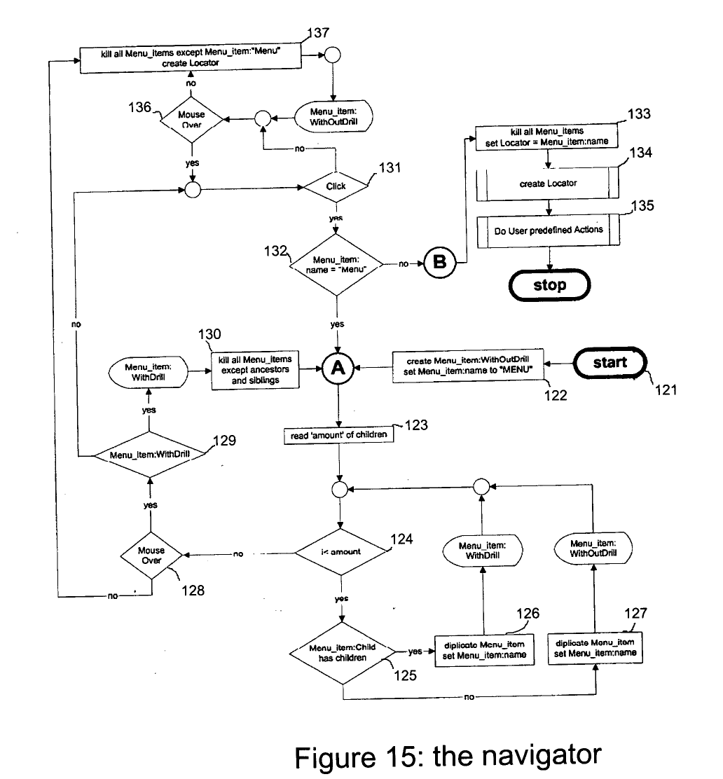

In step 306 a cloning process is executed for creating the complex drill-down menu. That creation will be more specifically described with reference to FIG. 15. Basically, each instantiation of the Menu_item class produces a clone which has two different states of the Topmenu state machine, as represented by block 308 (Menu_item Withdrill) and block 309 (Menu_item Withoutdrill). Indeed, while the number of clones or instances may be very diverse in accordance with the Cloning Control Instructions, however, each instance has only two different states: without or with the drill-down capability. Those two states are respectively represented by blocks 308 and 309. In step 307 of the cloning process of the Menu_item class, each state/instance receives specific attributes and properties in accordance with the Cloning Control Instructions necessary for further activities.

The Topmenu process waits for an interaction with the user, in step 310. In one embodiment, the user interacts with one instance of the Menu_Item object by a selection of the latter while, in another embodiment, it will be sufficient for the user to put the cursor over a specified area of the screen.

In step 311, the Topmenu.swf document causes the reading of the properties of the Menu_item instance which was selected, or with which the user interacted. As explained, the setting of the properties of the Menu_item instances were done during the step 310, in accordance with the CCI provided in step 304.

Assuming that the user interacts with one instance of the Menu_Item class having Withdrill, the process goes back to the step 306 for the purpose of a new cloning process of the drilling-down menu. Indeed, the new cloning process will be particularly described with reference to FIG. 15.

Assuming that the user interacts with an instance of the Menu_Item class which is WITHOUTDRILL, in that case, the process goes to steps 312, 313 and 314.

Step 312, step 313 and step 314 are simultaneously launched after step 311, when the user interacts with a Menu_item:WithOutDrill, and if the considered item is not the first one.

In step 314 (“Disable interaction with Topmenu”), the topmenu.swf causes the locking of the locator.

The launching of the business task is performed by step 312, while the creation of the locator is carried out in step 313. Those two processes will be explained in more detail with reference to FIG. 15. A new swf document is then loaded in the Observer.swf document, which is the contentscreen.swf document, with which the user will interact as shown in FIG. 14 by steps 315 (“do activities based on chosen Menu item”), step 316 (“enable locator”), step 317 (“kill content”) and step 318 (“wait for interaction”). It should be noted that, as for the observer.swf, the contentscreen.swf contains a set of classes of graphical objects which are appropriate for the considered business tasks, for instance, a contentscreen.swf may include a set of graphical objects such as a combobox, a listbox, an entrybox etc.

It should be noted that, practically, since the document only includes libraries of graphical objects which are needed for the different instantiations, the corresponding documents have a limited size. For a business application, a typical size of the Observer.swf document is about 100 Kbytes, while the Topmenu.swf document is about 30 Kbytes and the ContentScreen.swf document is about 10 Kbytes. Additionally, CCI strings of a few kilobytes are transferred from the server to the client, which ensures a very short time response.

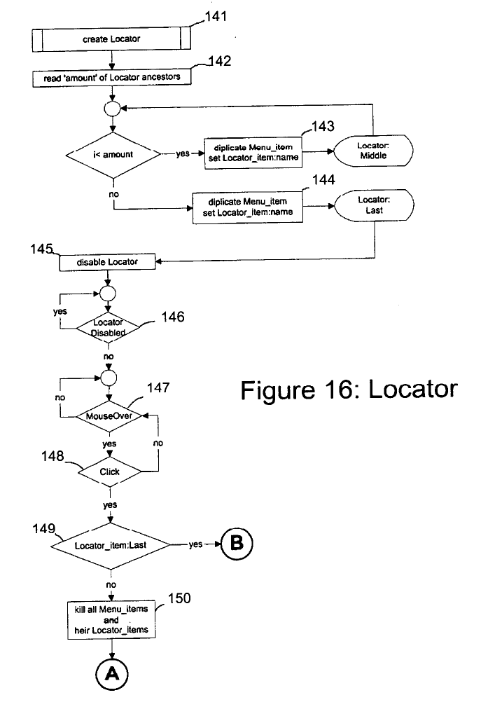

FIG. 15 and FIG. 16 respectively detail the cloning mechanism for the production of the navigator and the locator.

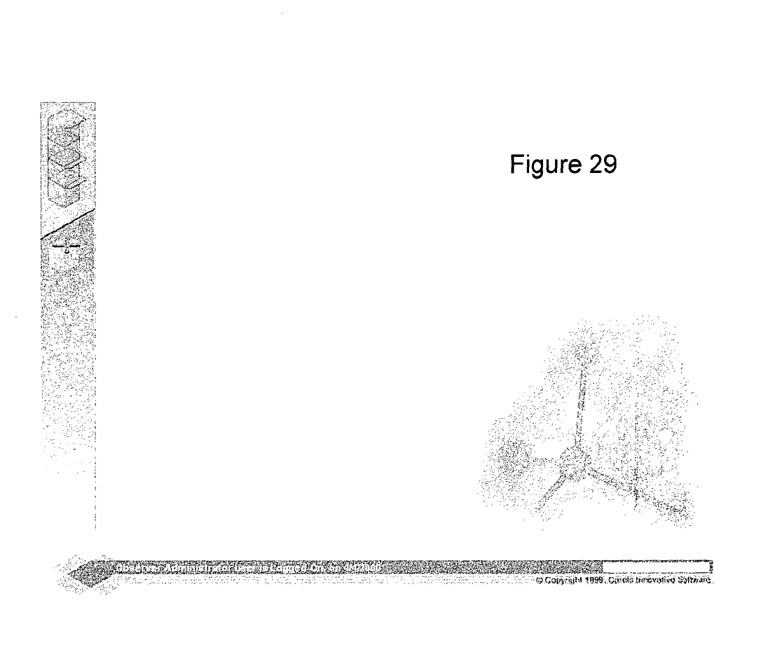

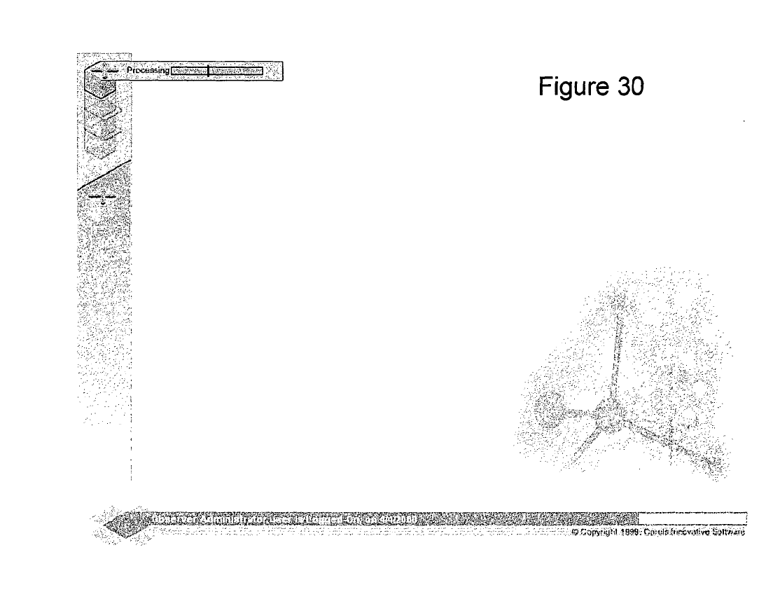

As mentioned above, each Tower object or instance has attributes and properties for launching the corresponding business application upon the selection by the user of the instance of the object. If the user clicks on one instance of the Tower object, the process goes to the construction of a new frame—the Content frame represented in FIG. 29—for gaining access to the data mining function of the business application. More specifically, the Content frame is an object which is used for any tower or business class and includes one element—the Topmenu which is part of the frame. The Content frame includes in the top left an anker to a new document which is a so-called Topmenu.swf document. The latter is not invisible but it causes the browser of the client machine to start the loading of the topmenu.swf document. Practically, this takes advantage of the capability of the plug-in container which is used to load successive documents so that only small entities (comprising reduced size libraries of objects) are used in accordance with the desire of the user and the scenario of the business application. The typical size for the Topmenu.swf document is 24 kbytes. It is received very quickly on most machines, even with a low speed modem connection and opened by the plug-in container.

When the Topmenu.swf document is loaded, the screen takes the form which is illustrated in FIG. 30 and a new second CCI stream is requested for the purpose of controlling a new cloning process. It should be noted that, as previously, the communication of the CCI stream is achieved by means of appropriate POST requests which are issued by the browser.

The CCI instructions are generated by the server and cause the assembling of a drill-down menu which will be superimposed on the Content frame of FIG. 29, and which will have, in the foreground, a drill-down menu for accessing data mining relative to the business task being considered. A typical example of a CCI stream is shown below. It corresponds to the elaboration of a drill-down menu for the “Project and Time Report” business task initiated when the user selects instance 233 of FIGS. 11 and 12.

&Menu_{—}01_{—}02=0

&Menu_{—}01_{—}02_C=Current

&Menu_{—}01_{—}02_S=TimeSheet

&Menu_{—}01_{—}02_SPath=HR

&Menu_{—}01_{—}02_F=Yes

&Menu_{—}01_{—}01=0

&Menu_{—}01_{—}01_C=List

&Menu_{—}01_{—}01_S=TimeSheet

&Menu_{—}01_{—}01_SPath=HR

&Menu_{—}01_{—}01_F=Yes

&Menu_{—}02_{—}02=0

&Menu_{—}02_{—}02_C=Project resp.

&Menu_{—}02_{—}02_F=yes

&Menu_{—}02_{—}02_L=Project responsible

&Menu_{—}02_{—}01=0

&Menu_{—}02_{—}01_C=BU resp.

&Menu_{—}02_{—}01_F=yes

&Menu_{—}02_{—}01_L=BU responsible

&Menu_{—}02=2

&Menu_{—}02_C=Report Gen.

&Menu_{—}02_A=Report

&Menu_{—}02_S=report

&Menu_{—}02_SPath=HR

&Menu_{—}02_L=This is for BU and Project responsibles only

&Menu_{—}01=2

&Menu_{—}01_C=Timesheet

&Menu=2

&men_item=Proj. and Time

&confirm=1

&end=

That string defines the different instances to be created from the unique Menu_item object or class which is contained within the library of objects. Each instance receives an instance name, a name to be displayed, and relevant information relevant to the hierarchy of the considered drill-down menu. By convention the “Menu_{—}02_{—}02” corresponds to the second child of the second branch, with respect to the root etc. The CCI stream defines the different properties of the different instances or items.

By convention, the _C sign defines the content property which is assigned to one instance, and the _A defines the action property, i.e., which action on the server is going to be triggered, such as a database access for instance.

It should be said that the format of the CCI in the preferred embodiment is mapped onto the used technology, but can be created in another format for example in XML.

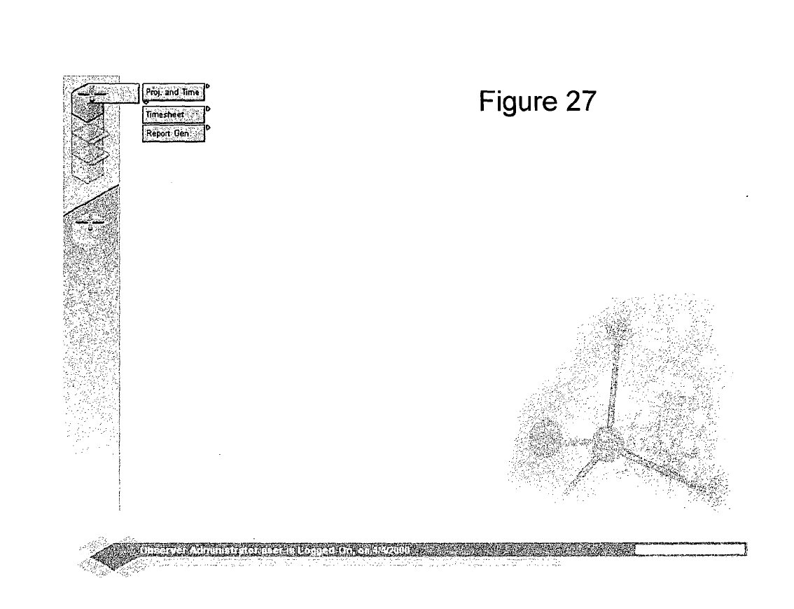

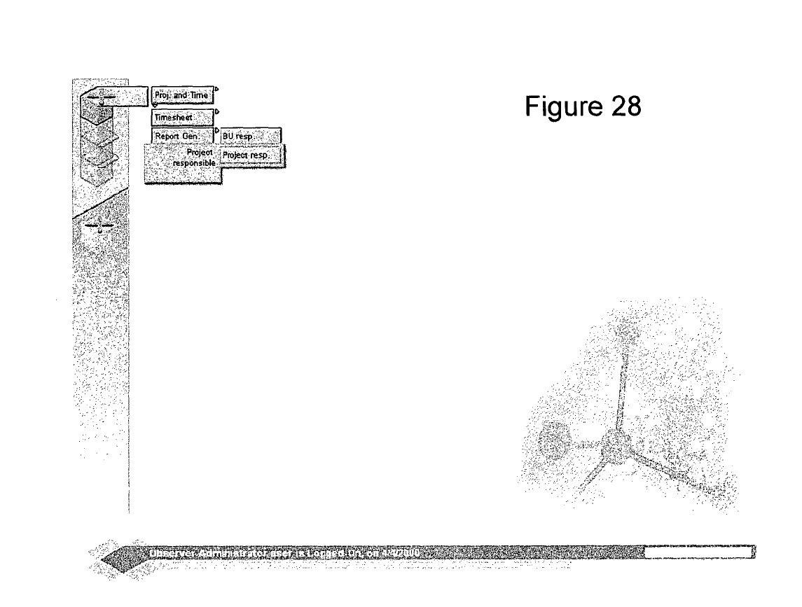

When the stream of Cloning Control Instructions is received from the server, and encapsulated within the Topmenu.swf document, the elaboration of the drilling-down menu is achieved. Such a drilling-down menu corresponding to the “Project and Time report” business task is illustrated in FIGS. 27 and 28.

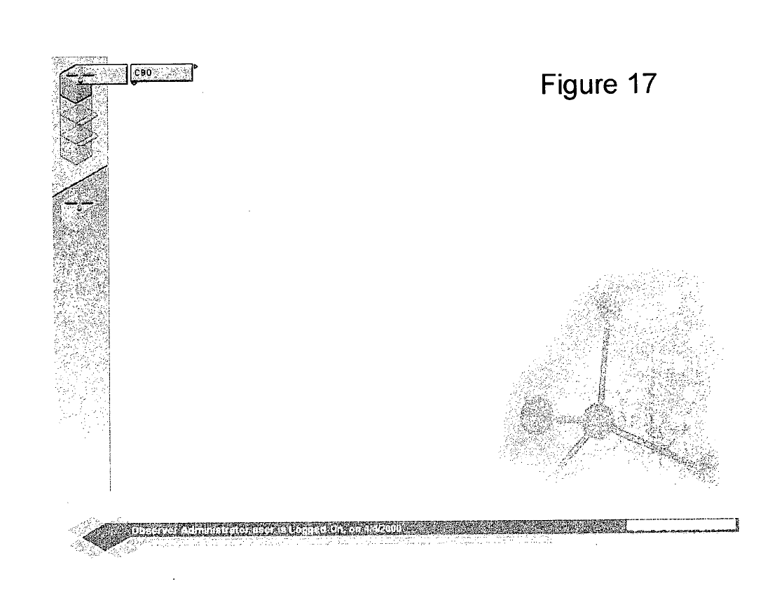

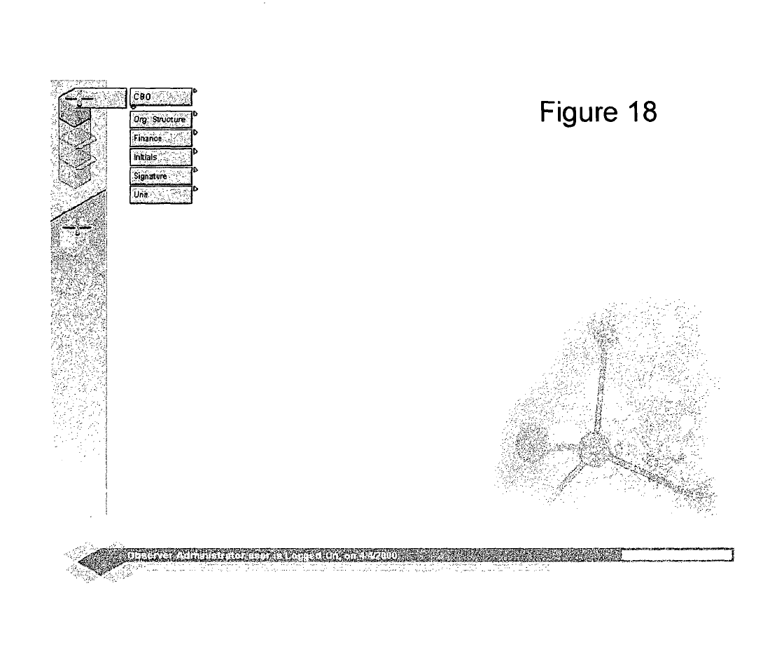

The elaboration of the drilling-down menu for the “Common Business Object” Tower will now be described. As for the “Project and Time report” task, the CCI instructions are used for creating the drilling-down menu corresponding to the CBO business application. The development of the drilling-down menu is successively illustrated in the FIGS. 17, 18 and 19.

With respect to FIG. 15 there is shown the process of elaboration of the drilling-down menu. The process starts in step 121. Then, in step 122, the process creates a first instance of the Menu_item object which is called the topmenu, i.e., it represents the higher level of the hierarchical structure of the drilling-down menu. That instance receives attributes and properties, and particularly a “Withoutdrill” attribute and an instance name which is “Menu” (it is not displayed to the user). The operations assigned to that instance consists of, practically, the calling of the CCI instructions provided by the server, and the reading of the Menu_C string for returning the name to be displayed in that topmenu instance. The first and top item of the drill-down menu is thus created and has received a name.

In step 123, the number of children relevant to the topmenu items is determined, which is achieved by reading the “&Menu=2” of the CCI string generated by the server.

The process then proceeds with a loop comprising steps 124, 125, 126 and 127 which consists of the successive elaboration of each instance forming a child of the topmenu item. The cloning capabilities and mechanisms are part of the Topmenu.swf document so that they are only transmitted once from the server to the client and form part of the properties available in the Menu_item class. The loop of step 124 operates as follows: for each child, there is a check (step 125) as to whether the latter has also children. In that case, the process goes to step 126 which consists of a duplication of the Menu_item object with the attribute “Withdrill” (since the considered child has also children). Conversely, the process proceeds to step 127 which is a duplication of the Menu_item class with the attribute “WithoutDrill”.

It therefore can be seen that that the drilling-down menu can be based on the same Menu_item object or class which can be used for multiple duplications and cloning processes.

The steps 124-127 therefore cause the generation of the first level of the drill-down menu. The first branch is created and waits for a further action. This action is determined by the user controlling the mouse, and particularly whether the mouse covers one particular instance, as tested in step 128.

If the test of step 128 returns a yes, then a further test is performed in step 129 for the purpose of determining whether the considered instance (on which the mouse is located) has the “WithDrill” attribute.

If this is true, then the process goes to step 130 where all of the instances of the Menu_item are killed, except for the ancestors and siblings of the considered Menu_item instance. The process can then return to the step 123 for the purpose of creating a new branch with the children of the selected item.

If the test of step 129 returns a False condition, then the process proceeds with step 131 which is a test for determining the occurrence of a selection of the considered item or instance of the Menu_item class.

If the user has selected the considered instance, then the process proceeds with step 132. Step 132 is a test for determining whether that instance is the higher level instance of the Menu_item class (i.e., the Topmenu instance), in which case the process goes back to step 123 for the purpose of recreating the first branch. In the reverse case, the process proceeds to step 133 where all of the instances of the Menu_item class are killed, except the first one, which is the Topmenu instance. Additionally, in step 134, the locator is set to the name of the instance which has been selected and, in step 135, the business task which is associated to the considered Menu_item is executed. The process is stopped when the business task is executed.

If the test of step 131 has returned a “no” condition, then the process proceeds with step 136 where the position of the mouse is checked again in order to determine whether it is still over the item which was considered in step 128.

If the test of step 136 returns a “yes” condition, then the process proceeds with step 131 again and, conversely, the process goes to step 137 where all of the instances of the Menu_item object are killed, except for the first one, which is the Topmenu instance. The Locator is then being created in accordance with the flow chart of FIG. 16.

FIG. 16 illustrates the process for creating and maintaining the locator which is an element providing a substantial advantage, since it provides continuous feedback on the accurate position of the user within the data mining structure. As mentioned above, the locator, when used in conjunction with the drilling-down menu (the navigator) provides a very effective navigation tool: the navigator-locator which saves space and allows an effective access to a complex data structure. It should even be noted that the navigator-locator can be used irrespective of any client-server application, and can be embodied in a local application running in a stand-alone computer.

The process for creating the locator starts on step 141. In step 142, a read operation of the CCI is executed in order to determine the number of ancestors. A loop is then initiated for the purpose of the creation of the “Locator-items”. More particularly, step 143 corresponds to the creation of the middle “Locator-items” where the loop ends via Step 144 where the last “Locator-item” is created. In step 145, the process locks the locator in order to prevent any changes which could be brought to the latter, as the Locator/Navigator may not be used during a started business process.

In step 146 a test is performed for determining whether the locator is being disabled. A test is then performed in step 147 for determining whether the mouse is over one item of the locator, and step 148 consists of the determination of a positive selection of the considered item by the user.

If the user appears to have selected the item, the process then proceeds with step 149 which is a test for determining whether the locator corresponds to the last item of the menu. If yes, the process proceeds to step B which leads to step 133 of FIG. 15. On the contrary, the process goes to step 150 which kills all of the instances of the Menu_item and the heirs Locator_items.

It can be seen from the description above that the cloning process which is executed on the classes or objects of the library embedded in the document opened by the plug-in container permits the creation of a large number of different items, elements and screens, including the very effective navigator-locator (illustrated in FIGS. 17-19), where the usual HTML way would require the creation, storing and maintenance of a huge amount of different HTML pages. The process shows a great flexibility and ease for designing complex applications.

FIGS. 20 to 28 are illustrative examples of the wide variety of different screens which can be assembled in accordance with the cloning process described above, and based on the use of one unique contentscreen.swf document.

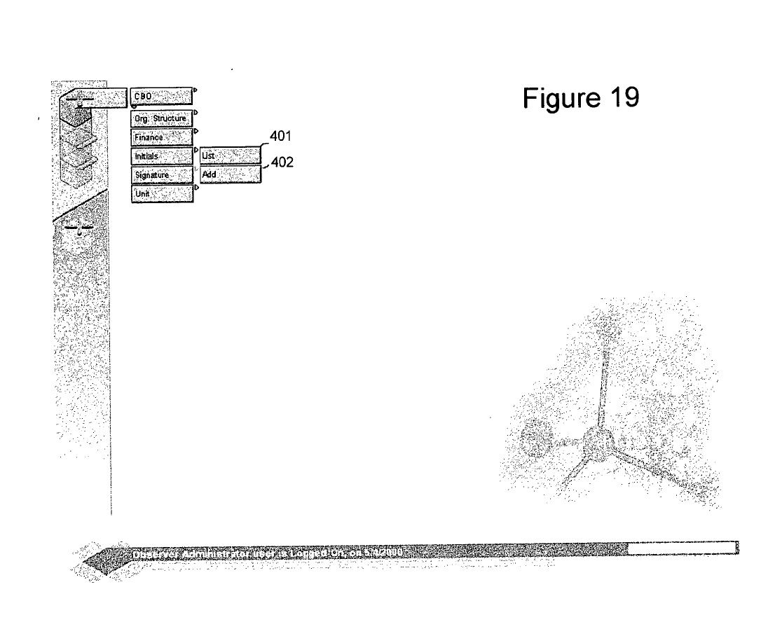

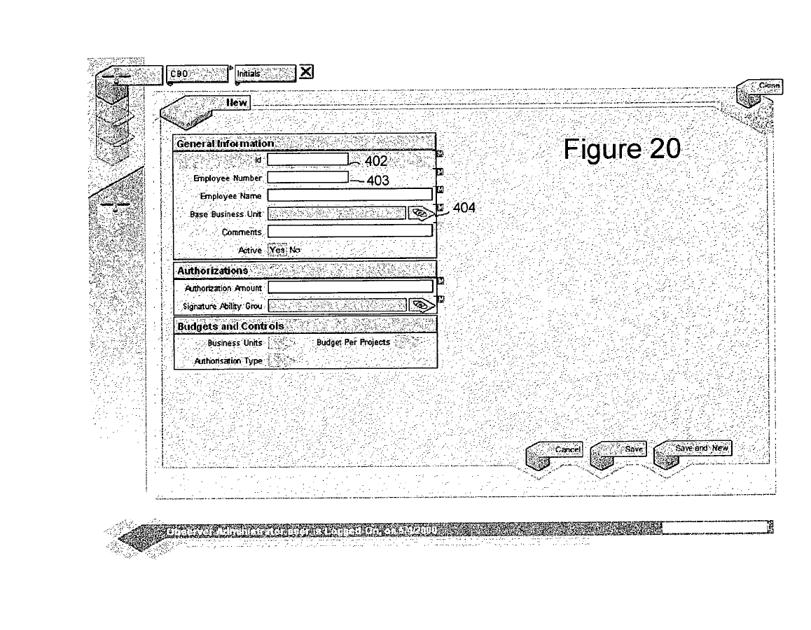

FIG. 19 shows the development of the CBO Menu_item, which shows that item “initials” has two distinctive children: a first “list” item (for giving an exhaustive list of the employees) and a second “add” item (for entering the references to a new employee). As explained above, the drilling-down menu of FIG. 19 is assembled by means of one unique Menu_item which receives attributes and properties, including data extracted from the database.

When the user selects the “Add” instance of the Menu_item class, the process proceeds to a new task. For that purpose, a new cloning process is initiated by means of a new stream of Cloning Control Instructions (CCI) produced by the server, for the purpose of elaborating a new screen which is that shown in FIG. 20. A set of objects are assembled for that purpose within the plug-in container, and particularly two entry boxes 402 and 403 for respectively receiving the id and Employee number to be typed in. Those two entry boxes are based on the same object but have different attributes and properties, including data extracted from the database, for fitting to the relevant information. For instance, entry box 402 may include the validation procedure of a first type, while the entry box 403 may include the operation of checking whether only numerical figures are being typed in. FIG. 20 also shows a Combobox 404 which is also one instance created from a corresponding object within the library.

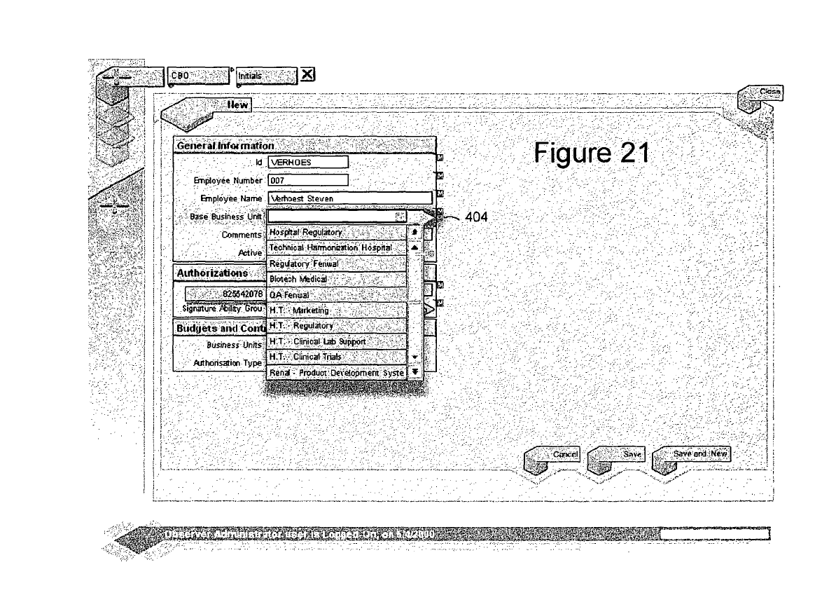

That combobox also receives attributes, operations and data which are controlled by the CCI instructions extracted from the property files or generated in real-time by the server. In particular, the different options that are displayed when the user wishes to make a selection, as illustrated in FIG. 21, are directly derived from the CCI instructions and, therefore, this entails the substantial advantage that any element can be individually modified by the process, contrary to what would be required in the usual HTML way.

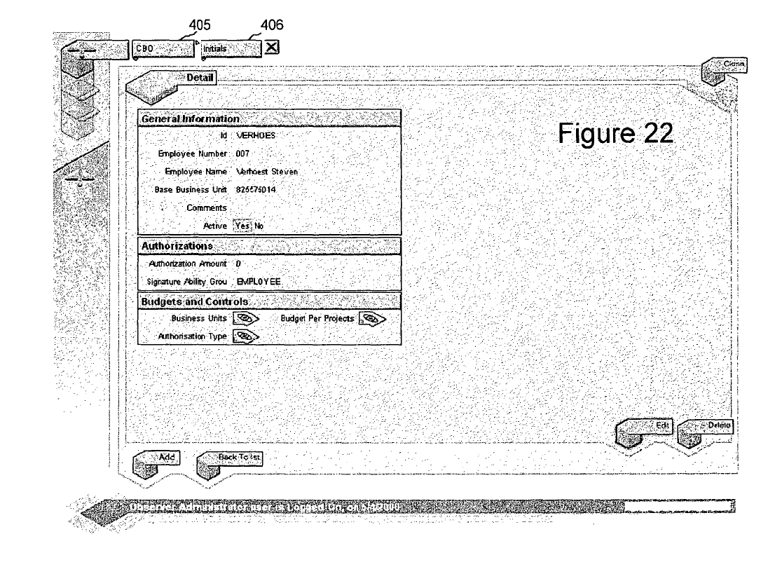

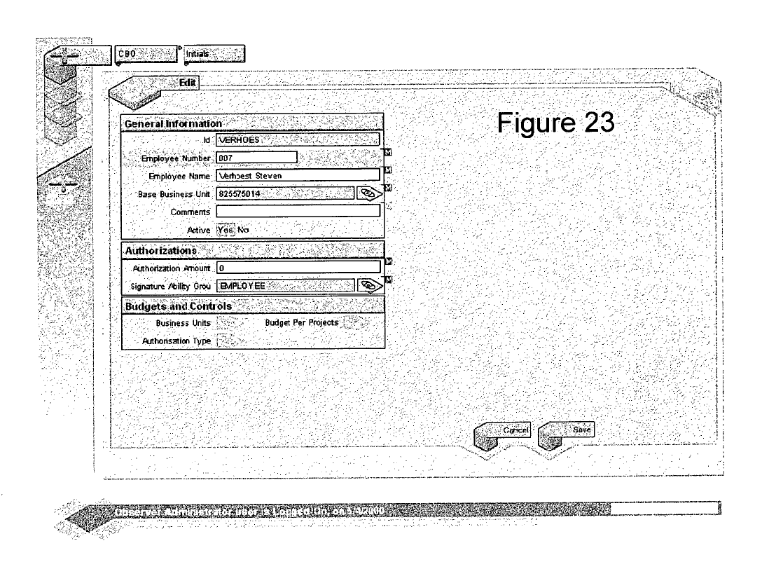

FIG. 22 illustrates the entering of information in the objects assembled within the plug-in container for the purpose of updating the remote database with a new employee. The Figure also shows the role of the locator which continuously provides the user with visual feedback (using a limited amount of space on the screen) for navigating within the data structure.

Should the user click on CBO (resp. “Initials”) in the item 405 (resp. 406), the user will directly cause the drill-down of the corresponding element. Specifically, the user may directly access the items which correspond to the children of the CBO topmenu item without any need to reload intermediate pages. It should be noted that the latter can only happen when the locator is enabled, in other words, the content needs to be closed first. This is to prevent the using the navigator-locator as long as a business task is running.

When the user selects “save” on the screen of FIG. 21, the cloning process is triggered for the purpose of assembling a new screen (corresponding to a new task) which is the “details” screen, as shown in FIG. 23. It should be noted that, for the purpose of assembling that screen, it is no longer necessary to transfer any information relevant to the last update brought to the database since the client machine has already received most of the information required for constructing the corresponding page: the name which was entered, the address etc. The new task to be performed (displaying an edit screen) and correspondingly the new screen to elaborate, only requires a new cloning process for new duplications for the purpose of creating the new screen. Regarding the traffic which is exchanged between the client and the server for executing that cloning process, it should be noted that the client only transmits the name of the appropriate property file which needs to be invoked on the server and only the result of the cloning process needs to be transmitted back to the server. Therefore, contrary to the usual HTML way, only a very limited amount of traffic via the network is required for assembling graphic components in the client, including attributes, behavior and data. Only a few kilobytes—corresponding to the new CCI stream—needs to be transferred between the assembling of screen of FIG. 21 and screen of FIG. 23.

Additionally, the different objects or instances can be individually amended in accordance with the cloning instructions loaded in the property files.

With the conventional HTML technique, if the user wishes to edit one particular field pertaining to one piece of information being displayed, the browser must request a new page containing an “entry field”. Obviously, the same data would be introduced in that new HTML page, which the server would have to send back to the browser. By eliminating the duplication of data transfer, this embodiment of the invention shows efficiency even when a low-speed modem connection is being used.

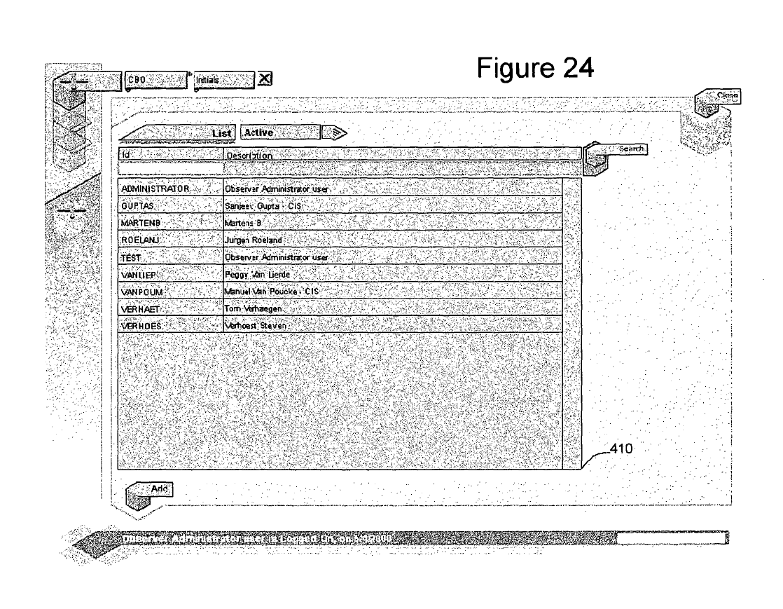

FIG. 24 illustrates the automatic assembling of a “list” task which is initiated when the user clicks on item 401 of FIG. 19. Again, the listbox 410 is an object which is contained within a library and which is used for executing a cloning process under control of the CCI which are received from the server. The CCI determine the attributes, properties and data which are required for the assembling within the plug-in container. In the particular list box which is illustrated, the duplication was achieved with a CCI stream defining nine elementary lines, each one being assigned to one individual from the company etc.

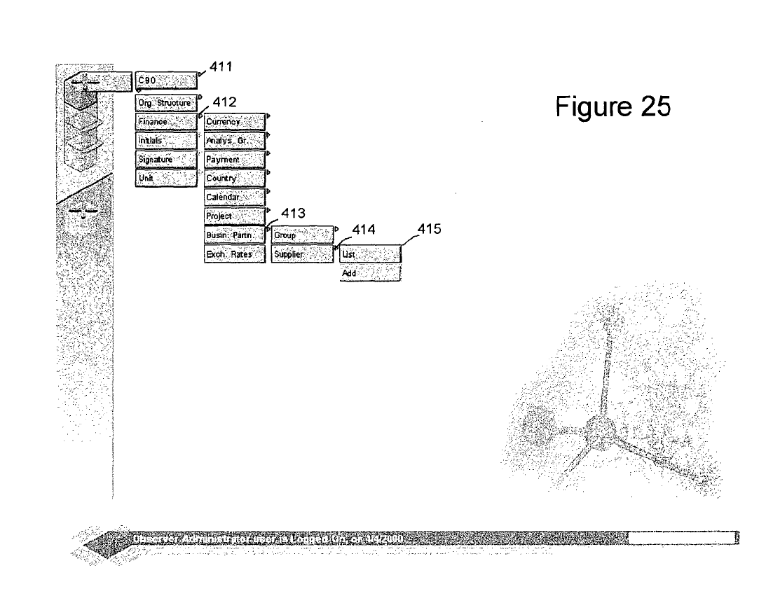

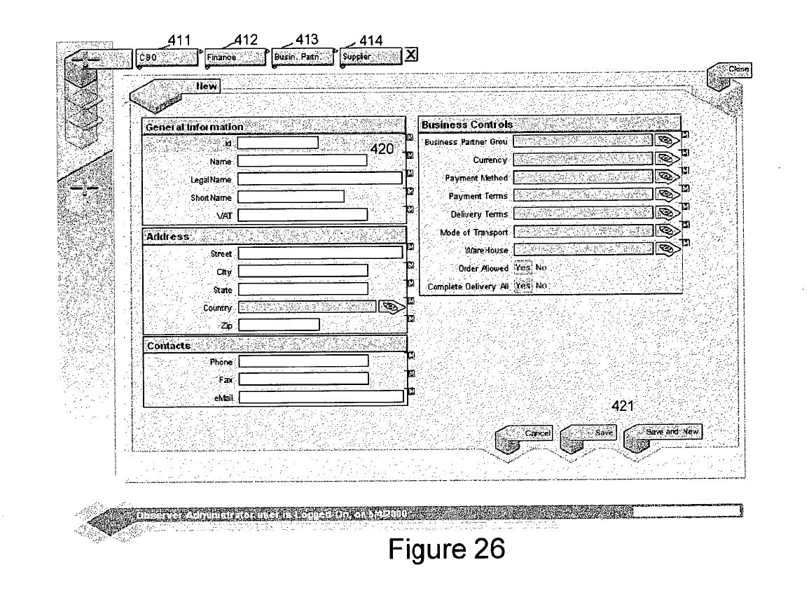

FIG. 25 shows the drilling-down menu which appears particularly elaborated and FIG. 26 shows the action which is executed when the user successively points to “CBO” (item 411), then to “finance” (item 412), then to “Business Partners” (item 413), then to “Supplier” (item 414) and, at last, to “add” (item 415). The generation of the different instances or items of the Menu_item class are automatically produced when the user successively moves the mouse over the different items. No selection is required at that stage, what is a great advantage with respect to the usual HTML way which requires intermediate loading of the different pages (requiring a long time) before the user is allowed to gain access to the information the user wants. By the use of the cloning process described above, and associated with the drilling-down menu, the latter may have a direct access to any point of the data structure. Even if the user clicks on one item for instance “add” item 415, thus causing the triggering of a new property file and the assembling of screen of FIG. 26, the user still keeps total access to the data structure thanks to the locator, i.e., items 411 to 414, which is created in accordance with the process of FIG. 16.

As was mentioned above, the same generic element of each type, be it a button, one combobox and one listbox for instance, can be used for automatically assembling a wide range of screens. There it is possible to adapt, in accordance with the cloning instructions defined in the property files, the different generic object to the wide range of situations which are needed for accessing the database. The size of an entry box and the different number of options are adapted to a particular need. Therefore the same graphical components can be used for producing all of the different screens which will be displayed to the user. In addition to the logic for performing the corresponding behavior, for instance the action which is to be executed when the user clicks on a button or the opening of a series of options for selection in a combobox, each generic graphical component receives the associated logic for achieving duplication and cloning of the object. Each generic object or component has the particular logic for performing the corresponding operation and behavior which is expected, but also receives the possibility of duplication and cloning as will be shown below. Therefore the same generic button will serve for creating two, three or more buttons on the screen if appropriate, as will be described hereinafter in more detail.

In addition to the setup graphical library, the invention uses a process for controlling the generating of the assembling of the objects on the screen which is based on instructions loaded into property files stored in the server. Each graphical object, be it a button, a combobox, or a listbox, which is being displayed at one instant on the screen has received the name of one particular property file with which it is associated. When the user selects this object, the latter invokes the particular property file which is loaded in the server. This is achieved by means of the browser issuing a TCP/IP message forwarding the name of the property file to the server. The corresponding property file contains the set of instructions which are necessary for automatically assembling at runtime, by means of the plug-in allowing a vectorized generation tool, the different graphical objects required for the next screen that is associated with the action requested by the user. Among this set of instructions is the subset of graphical objects which is involved in the assembling of the next screen.

It will be now be discussed, for the sake of illustration, a preferred embodiment of the invention which takes advantage from the XML standard for conveying the CCI instructions in order to provide an efficient so-called “thin-client” front end that are fully XML-based and that offer the efficiency, ergonomics, and speed that are required for transaction-intensive eBusiness applications because it extends the benefits of XML directly into the client web browser. This embodiment provides an object-oriented, XML-based User Interface (UI) Framework for the development of extremely efficient thin-client web front-ends and is universally applicable universally, which means that it can be used as well to web-enable existing (legacy) applications as for new eBusiness applications. One is allowed to “compose” User Interfaces for thin-client applications in a graphical and rapid way.

The main advantages of the thin-client approach can be summarized as follows:

more efficient way to distribute information across global heterogeneous

networks

ease of use through a single browser/applet viewer platform

host based computing

faster deployment

zero client configuration

zero maintenance on the client

stabilility

As known by the skilled man, the term “thin client” is used as a synonym for the Net PC or the network computer (NC). The term referred to personal computers for business purposes that were designed to be centrally-managed, configured with only essential equipment, and without CD-ROM players, diskette drives, and expansion slots (and therefore lower in cost).

XML offers the possibility of creating Controllers that will provide XML based data. The XML data can be translated into HTML. using XSL extensible Stylesheet Language. The “extensible Stylesheet Language Transformation” (XSLT) is a programming language that allows XML documents to be transformed from one scheme to another or into entirely different forms, such as HTML pages, WML cards, or PDF files.

It can be seen that, in the preferred embodiment, there is provided a general environment where “Graphical Components”—the GCs—work in conjunction with “Cloning Control Instructions”—the CCI's—which result in “screens” built at runtime in the user's browser. These screens are being enabled to receive, show and send XML data, to load new UI parts, and to change their behavior. Using Object Oriented terminology this could be explained as follows. The GCs are small components that behave like classes, which can be initiated by the set of CCI instructions. The CCI is the instruction set for the GC, the CCI initiates the GC and makes it behave as is defined in the CCI, calling and cloning as many GCs as necessary.

By graphical components, we are referring to the basic components—the atoms of an application:

The form

The button

The grid

The navigation system

In addition are the tab, the tree, which give the invention even more flexibility as a UI framework. The GCs are the building blocks of the application screen. Each element has its own latent functionality which is invoked by instructions defined in the CCI (a grid e.g. has the potential to show data in a number of rows and a number of columns). Not all components have real functionality. Some components are libraries from which other GCs can get elements. If the element is changed, it will be changed everywhere. Because the invention is component based, it can be extended, with custom created components, to handle highly specialized functions.

In the preferred embodiment, the CCI or Cloning Control Instruction is responsible for two distinct functions in the process. First it defines the screen and secondly the interaction. The CCI is an XML based procedure which consists of a set of methods and properties. A part of the (instruction) set instructs the GCs where they have to position themselves on the screen, their width and height, color, etc. In brief: pure presentation aspects. Another part of the CCI prepares the GC for the presentation of XML data when XML data is presented to the GC: which part of the XML needs to be shown and where does it have to be displayed.

Finally the CCI also contains pure interaction definition information. It describes when a button is pushed, which data has to be sent to which server controller, or when data is received, whether other processes have to be invoked or which data has to be sent. In short the CCI's describe the whole application's User Interface logic. It does so in virtual terms as a sort of “potential” screens pool, consisting of various individual building blocks, each getting their presentation logic and behavior at run-time. This means that the system of the present embodiment does not construct screens on a page-per-page basis but on a an element-per-element basis. This offers a profound advantage in flexibility, efficiency, and speed as compared to any other (HTML-based) web-interface.

As explained above, it can be seen that the description of an application is not integrated in any technology. Whatever future technology will be used to create the GC, if the GCs are CCI enabled, the application can switch immediately to the new technology.

It can be seen that every aspect in this preferred embodiment of the invention is XML based. It works natively with XML data, the screen presentation and interaction are described in an XML based language, and outgoing data is formatted into XML via a scheme like language, also known under the term “Ergon Structure Data” or ESD. Even inside all communication between the components is XML-based. In this particular embodiment, the system is clearly an XML based solution.

As it was already mentioned, every aspect of the system is extendable. The system is the combination of the CCI's with a set of Graphical Components. CCI's are embodied in a subset of the open XML standard, and Graphical Components, which can be developed in any technology as long as that technology has all the critical attributes necessary—vector based, XML capabilities, Object Oriented. The invention permits that every aspect of the system is object based and thus easily expandable. Another aspect of the system which turns it into a framework, is that it gives one all the elements to create a successful web application without compromising on any of ones requirements. If a functionality is not covered by any of the available GCs, a special one can be created. No screen is pre-defined. The system is compliant to all past, present and future XML data Subsets (edXML, cXML, biztalk, . . . ) because the very nature of the system is to work with XML data without restricting us to subsets.

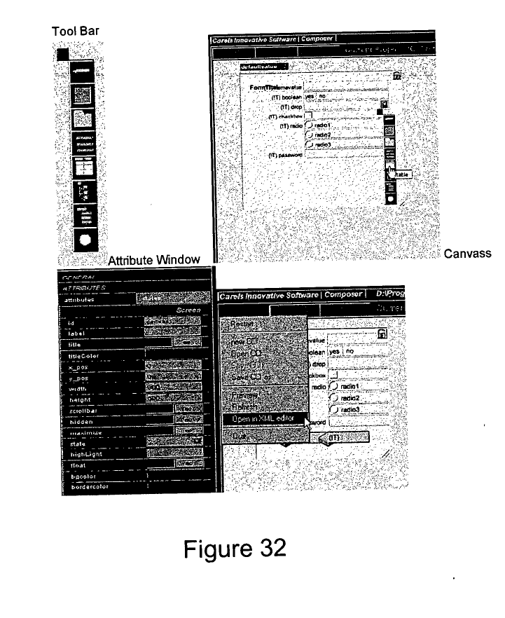

Because the CCI's are XML based in this preferred embodiment, it can be seen that it is possible to create the CCI's with a simple editor such as Notepad. In the preferred embodiment, there is provided a special WYSIWYG-interface (what-you-see-is-what-you-get), a Composer, an illustrative view of which being given in FIG. 32. The Composer creates the CCI's in a drag and drop environment. Development is possible without using servers by using dummy XML data. The dummy XML data can be installed locally providing complete simulation of every aspect of the application, thus creating an environment for front-end creation, and for prototyping. With the composer, one can visually build the interface, positioning the buttons, grids, menu, forms utilizing the drag and drop protocol.

The Graphical Components (GC's) can, as mentioned before, be based on present or future technology. The system uses Graphical Components built on the Macromedia Flash™ technology since the latter has OO capabilities, and is vector based and, further, it can handle XML technology. It is thus clearly applicable to the transport of the Cloning Control Instructions which were described above.

The use of the Composer offers a very intuitive and flexible way to compose web User Interfaces. Designers can now concentrate on the design and bridge this seamlessly to the application logic. It allows for a fast prototyping of User Interfaces which can be tested quickly with a standard XML data model, and which can be adapted flexibly throughout every stage of the application development.

It is a true thin-client framework. This means that it allows for a clear cut separation of application logic and presentation logic. First of all, this guarantees an easy maintainability of applications as changes can be made by programmers and designers in their respective domains, independently of each other. Furthermore, the thin-client approach optimizes processing and transactions between client and backend server. All application logic (including the CCIs) reside on the server. The processing power of the server is optimally used and only tiny data packages and the required Cloning Control Instructions (CCI's), travel between the backend server and the thin-client.

This is a clear advantage of the invention over the known traditional web-enabled application, where the final stage of communication between the backend server and the web-client involves the transformation of data into an HTML page, which is pushed to the client for presentation. As mentioned above, this is very time-consuming, and the traditional technique involves pushing a lot of redundant information back and forth. Conversely, the present invention operates on an element-per-element basis. If an event is generated on the client, only the involved XML data travels to the server, and only the requested XML data travels back. This includes the specific presentation logic necessary for presentation on the client. In this way screen redraws are eliminated and bandwidth related speed problems are overcome. All this data, with its logic, is embedded in the tiny CCI data packages.

This preferred embodiment is clearly XML based. It works natively with XML data, the screen presentation and interaction are described in an XML based language, and outgoing data is formatted in XML. Even within the system, all communication between the components is XML-based. This ensures that it is open and can connect to any application capable of receiving and sending XML.

The following benefits are provided:

It improves the ROI of legacy applications and capitalizes on the existing business logics;

it preserves legacy software

it accelerates the time-to-market of eBusiness initiatives

it cuts back the development and maintenance costs of applications

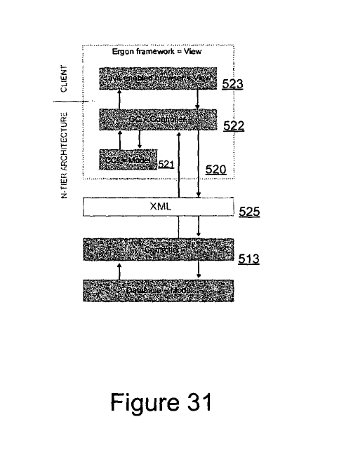

In FIG. 31, there is shown a general architecture of the preferred embodiment. The controller 513 interfaces via XML interface 525 with the framework 520 which includes a CCI controller 521and a GC controller 522 which interface with browser 523 to create a view. FIG. 32 illustrates the screens used by the GC controller to generate the graphical components whith the CCI attribute.

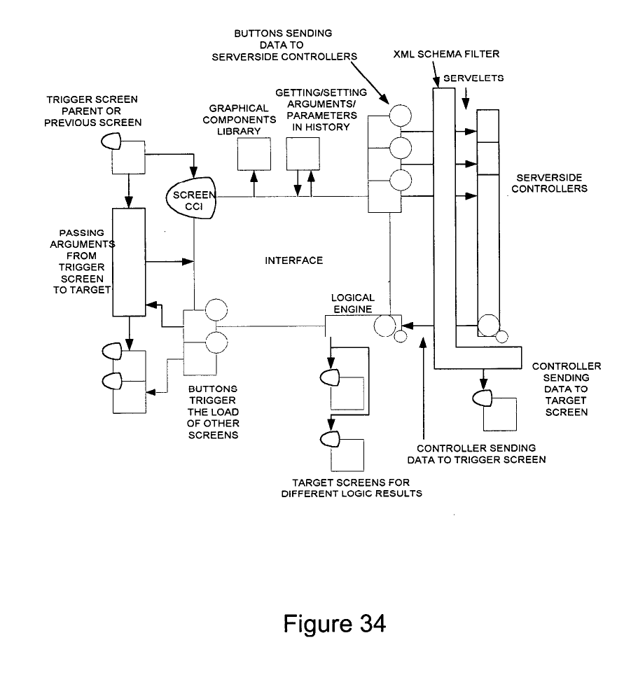

FIG. 34 is a detail of the framework 520 which shows the interaction, flow and execution between the controllers and the screen buttons and screen views for the user. The framework enables dynamic building of applications. Moreover, although an interface is shown using XML, voice XML can also be used to send voice instructions to a client or distribute audio to a client. Additionally, instead of communicating using servelets, one can execute a URL and go to and get information. The servelets can be replaced by other instructions and applications and/or combinations thereof. In another embodiment, XML can be replaced with Real Audio and/or Real Video or analogous software. The framework permits dynamic building of applications in real time with no need for compiling.

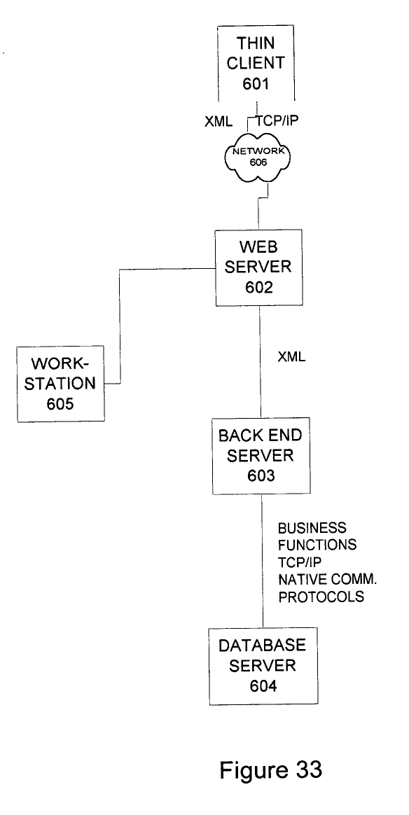

FIG. 33 illustrates the system of the preferred embodiment of the invention wherein the thin client 601 has a browser and a plug-in such as the Macromedia Flash container which is an industry standard used for building applications. The client interfaces with a server 602 using XML and TCP/ip over network 606 which can be the Internet, an intranet or other network. The server can be a conventional HTTP server and has the software to carry out the functions of the framework shown in FIG. 41. The server is ported to a workstation 605 which can be a conventional computer using an operating system such as a Windows NT, Macintosh or the like. The workstation includes a visual development environment for creating applications to run in accordance with the framework on server 602. The back end server 603 communicates with server 602 using XML and it can be a conventional server running SAP R/3 or the like. It carries out the business functions of the system and interacts with the database server 604 which can also be a conventional server capable of running Oracle and the like. The servers 603 and 604 carry out the business functions using TCP/IP native communication protocols.

The navigator according to the preferred embodiment of the invention, as enabled by the framework on server 602 and as operational in the client 601, provides the user with the ability to drill down n levels without retracing ones steps through the intermediate levels. This provides a faster and simpler method of navigating.

With respect to the Model-View-Control (M.V.C.) “paradigm” which is well-known to the skilled man, it can be seen that now it is very easy to separate in an application program designed for the Internet the coding from the design work. The invention clearly permits to easily separate the View (e.g. HTML) and Control (coding e.g. Java, VB, etc.) and to provide designer with tools to modify the presentation without requiring the assistance of the programmer, while the latter can concentrate on the application logic. The invention clearly deviates from the traditional way of designing MVC systems. Each View is build on demand thanks to the use of the CCI instructions, and each view requests data from the model every time it is initiated. Hence, there is no Model to View notification. There is simply the creation of the View object which has to request any necessary data from the model.

1. Process for automatically generating and controlling, in a client-server environment, a set of graphical objects which are to be assembled in a plug-in container associated to a web browser, said graphical objects forming a library of classes which can produce clones having attributes and operations which are to be assembled into said plug-in container and displayed on the client's computer screen, the cloning of said objects being under control of cloning instructions which are loaded into said server and required for corresponding elementary tasks,
said process involving the steps of:
cloning under the control of one property file on the server a set of objects comprised within said library and which are involved by said task;
assigning to each clone the attributes and operations required by said task, said operation comprising the triggering of one associated property file containing cloning control instructions (CCI) or producing at run-time said CCI instructions for the purpose of the execution of the next task;
assembling the different clones into said plug-in container which is associated to the browser in the client's computer.

2. Process for assembling on a client a set of graphical objects in a client-server environment, said library being compiled in order to produce a document which is dedicated to a container or plug-in associated with a browser in a client machine;
said process involving the steps of:
arranging a library of graphical objects having attributes, operations and cloning capability for the purpose of assembling a set of instances of said objects on the screen;
arranging a set of property files loaded on the server for the purpose of loading the cloning instructions which are to be applied to some graphical object in order to produce said instances; and creating an association between each particular instance and one property file;
causing the selection of one particular instance on the client screen to trigger the associated property file containing cloning control instructions (CCI) or producing at run-time said CCI instructions for the purpose of controlling a new cloning process and generating a new screen;
whereby the result of the cloning process executed under control of the cloning instructions causes the automatic assembling of the appropriate instances of the objects of said library.

3. Process according to claim 1 or 2 characterized in that the client-server application is used for accessing a data base and that the cloning instructions of the property files also controls the assignment of data extracted from the data base to the considered instances of the graphical objects.

4. Process according to claim 3 wherein said library comprises a button object which receives, during the cloning operation, attributes and operations for invoking, in response to the user making a selection, a corresponding set of CCI instructions on the server for the purpose of executing and controlling new cloning operations.

5. Process according to claim 3 wherein said library comprises a combobox object, which receives, during the cloning operation, attributes with data extracted from the data base, and also operations for particularly invoking, upon a selection from the user, a corresponding set of CCI instructions on the server for the purpose of executing and controlling new cloning operations.

6. Process according to claim 3 wherein said library comprises a listbox object which receives, during the cloning operation, attributes with data extracted from said data base, and also operations for particularly invoking, upon a selection from the user, a corresponding set of cloning instructions extracted from a property file or produced at run time by the server for the purpose of executing and controlling new cloning operations.

7. Process according to claim 3 wherein said library comprises an object being a container receiving attributes, including data from said data base, and operations for creating clones which also has cloning capabilities controlled by cloning instructions derived from a property file or produced at run-time for the purpose of executing and controlling new cloning operations; each clone being arranged in a hierarchical manner on the screen so as to produce a set of instances aggregating a drilling-menu.

8. Process according to claim 7 each instance comprised in said aggregated drilling-menu receives an operation which causes the triggering of an associated property file or the production at run-time of an associated CCI string for controlling new cloning operations,
whereby there is provided a direct access to the data structure of said data base.

9. Process for producing a document in an application which is to be opened in a plug-in container of a web browser comprising the steps of:
arranging a library of graphical components consisting in classes receiving attributes defining the corresponding position and object to be displayed with the associated data and operations which are to be performed upon selection by a user,
arranging a set of property files stored on the server or produced at run time which contain cloning instructions for the purpose of producing instances of said graphical components of said library;
producing one document to be opened by said plug-in container involving some instances which are cloned in accordance with the cloning instructions contained into the property files, and each of said instances receiving an operation which causes the triggering of one property file for controlling new cloning operations;
invoking, upon selection of one particular instance, the associate property file in order to control the cloning process of new instances which are to be assembled on the screen.

10. Process according to claim 9 characterized in that the application is a data base application and wherein the operations which are executed when a user selects one instance causes an access to the data base and the triggering of the property file associated to said selected instance for causing a new cloning process and producing new instances of graphical objects with attributes, operations, including the extracted data from said data base.

11. Navigation process for exploring a data structure within a computer system, said data structure involving a set of hierarchical pages of data which can be accessed by the user; said process involving the steps of:
displaying a locator showing the history line of the page being currently displayed within the hierarchical structure;
in response to the user actuating a pointing cursor on one precise location of said locator, displaying a drilling menu which develops the structure with respect to the current position being pointed,
whereby the user may navigate within the data structure with a minimum of space required.

12. Navigation process according to claim 1 or 2 characterized in that it is used in a client-server application for accessing a remote database wherein the messages being exchanged between said client and said server comprises a coded representation of the hierarchical structure of data so that the latter is directly accessible to the client.

13. Apparatus comprising means for carrying out the process defined in steps 1 to 10.

14. A computer program product comprising computer program code stored on a computer readable storage medium for, when executed on a computer, performing all the steps of claim 1 to 10.

15. Process according to anyone of claim 1 to 12 for accessing a database via a Global Communication Network such as an Internet network or a WAP (Wireless Application Protocol) based network.

16. Process for automatically generating and controlling in a local machine a set of graphical objects, said graphical objects forming a library of classes which can produce clones having attributes and operations which are to be assembled into said plug-in container and displayed on the computer screen, the cloning of said objects being under control of cloning instructions which are loaded into the local machine or generated by a local process and which corresponds to a given task,
said process involving the steps of:
cloning under the control of cloning instructions a set of objects comprised within said library and which are involved by said task;
assigning to each clone the attributes and operations required by said task, said operation comprising the triggering of one associated property file containing cloning control instructions (CCI) or producing at run-time said CCI instructions for the purpose of the execution of the next task;
assembling the different clones into said plug-in container which is associated to the browser in the client's computer.

17. Process for automatically generating and controlling, in a client-server environment, a set of graphical objects or components which are to be assembled in a plug-in container associated to a web browser, said graphical objects or components forming a library of classes which can produce clones having attributes and operations which are to be assembled into said plug-in container and displayed on the client's computer screen, said process involving the steps of:
transmitting to said browser said graphical objects and said components for the purpose of creating a predetermined graphical screen on the client's computer;
controlling said graphical objects or components by means of cloning control instructions (CCI), said cloning control instructions (CCI) calling and cloning as many graphical objects or components which are necessary and further controlling their behaviour.

18. Process according to claim 17 characterized in that said CCI define the presentation aspects of the graphical objects, such as the position on the screen, the width and height, color, and further define the data which are to be presented in relation with said graphical objects for controlling their positions, size, colours.

19. Process according to claim 18 characterized in that said data is extracted from a remote database associated to said server.

20. Process according to 1 wherein each graphical object is being created via a specific user-interface, for instance a WYSIWYG-interface (what-you-see-is-what-you-get) having drag and drop capability, which permits to visually build a screen comprising different graphical objects, and define their position and behaviour and automatically generate the CCI instructions.
